(19) United States
(12) Patent Application Publication
(10) Pub. No.: US 2010/0028845 A1
(43) Pub. Date: Feb. 4, 2010

(54) TRAINING SYSTEM AND METHOD

(76) Inventors: Jason T. Myer, Wylie, TX (US); Craig Milum, Phoenix, AZ (US)

Correspondence Address: LAW OFFICE OF MICHAEL A. BLAKE, LLC, 95 HIGH STREET, SUITE 5, MILFORD, CT, 06460, US

(21) Appl. No.: 12/403,107

(22) Filed: Mar. 12, 2009

Related U.S. Application Data
(60) Provisional application No. 61/036,371, filed on Mar. 13, 2008.

(51) Int. Cl. G09B 5/06; G09B 7/00

(52) U.S. Cl. 434/323; 434/362; 434/327

(57) ABSTRACT

A training system comprising: a terminal, a cpu located in the terminal; a storage means in signal communication with the cpu; an input means located on the terminal and in signal communication with the cpu; a terminal screen located on the terminal and in signal communication with the cpu; a training module located on the storage means, the training module comprising: at least one training video with user selectable chapter markers located at programmed intervals on the training video; an employee evaluations module located on the storage means that alerts a supervisor when an employee should receive training on a specific subject, when an employee has watched certain videos and has completed training, and that provides results and analyses of all employee quizzes to the a person directed by an operator of the training system.

### CROSS-REFERENCES

This patent application claims the benefit of provisional patent application Ser. No. 61/036,371 by Jason T. Myer and Craig Milum, entitled “Training Apparatus”, filed on Mar. 13, 2008, the entire contents of which are fully incorporated by reference herein.

### TECHNICAL FIELD

The present invention relates to educational equipment for training generally related to work organizations, but, may be used in other activities as well, and in particular to an audio/visual apparatus which is located at a stationary or portable work station to provide instruction on a plurality of job tasks that a worker is to perform at that location.

### BACKGROUND

Many organizations have jobs which require training. It is often difficult and time consuming to train a new employee, or to train an experienced employee in a new job skill or concept that relates to the organization's activities. Training is often done by a “teacher” who may not remember to explain all pertinent aspects of an activity or may attempt to train with explanations that are not well thought through and are likely to be confusing to the trainee. Additionally, the organization's s role may be further complicated due to relatively high turn-over rates associated with many jobs. In a high turnover organization, continuously provided training programs may be required for new employees, or employees learning new skills, which can be very time consuming, manpower intensive, and costly. Traditionally training is one of the most important and time consuming activities of a manager, supervisor, or lead person.

The workforce is changing rapidly, with many people entering the workforce where English is not their first language. Finding instructors for job training in an employee's native language may be problematic and costly.

It is difficult for operations management of an organization to keep current with an each employee's state of training and demonstrated understanding.

Training is often tedious and often does not encourage the trainee's active interest and concentration. Learning is generally improved if the training is interactive with responses and activities required of the student during the training.

Training, particularly provided by electronic or printed media is often created for a whole industry. Learning is generally improved if the training is specific to the individual's work site, persons, places and actual routines rather than generic and vaguely applicable in a universal sense.

Many elements of a person's job while important are only performed infrequently and are somewhat complex and may be closely related to a safe work environment, so that it is important for the trainee to review and relearn the material through repeated exposure on a schedule that varies due to the nature of the task and for which it is necessary for the management to ensure reliably occurs on the designated schedule.

Thus, it is desirable to provide automated, interactive, instructional aids specific to the trainee's work organization and actual work site near the location at which the work tasks are being performed for initial training and then repeated as helpful and tracked to ensure conformance with governmental and organizational requirements for task understanding, that overcomes the above listed and other disadvantages. It is also desirable to provide management with accurate information concerning training and learning status for each employee.

### SUMMARY

The disclosed invention relates to a training system comprising: a terminal, a cpu located in the terminal; a storage means in signal communication with the cpu; an input means located on the terminal and in signal communication with the cpu; a terminal screen located on the terminal and in signal communication with the cpu; a training module located on the storage means, the training module comprising: at least one training video with user selectable step markers located at programmed intervals on the training video; an employee evaluations module located on the storage means that alerts a supervisor when an employee should receive training on a specific subject, when an employee has watched certain videos and has completed training, and that provides results of all employee quizzes to the a person directed by an operator of the training system.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a simple schematic diagram of one embodiment of the disclosed system;

FIGS. 2-21 are screen captures from the disclosed system;

FIGS. 22-34 are diagrammatic illustrations of the disclosed system;

FIG. 35 is a flowchart showing one embodiment of the disclosed method;

FIGS. 36-44 are diagrammatic illustrations illustrating how the disclosed training system may be structured in a Retail embodiment;

FIGS. 45-51 are diagrammatic illustrations illustrating how the disclosed training system may be structured in a Health Care embodiment;

FIGS. 52-60 are diagrammatic illustrations illustrating how the disclosed training system may be structured in a Hotel embodiment;

FIGS. 61-66 are diagrammatic illustrations illustrating how the disclosed training system may be structured in a general industry embodiment; and

FIGS. 66-74 are diagrammatic illustrations illustrating how the disclosed training system may be structured in a production embodiment.

### DETAILED DESCRIPTION

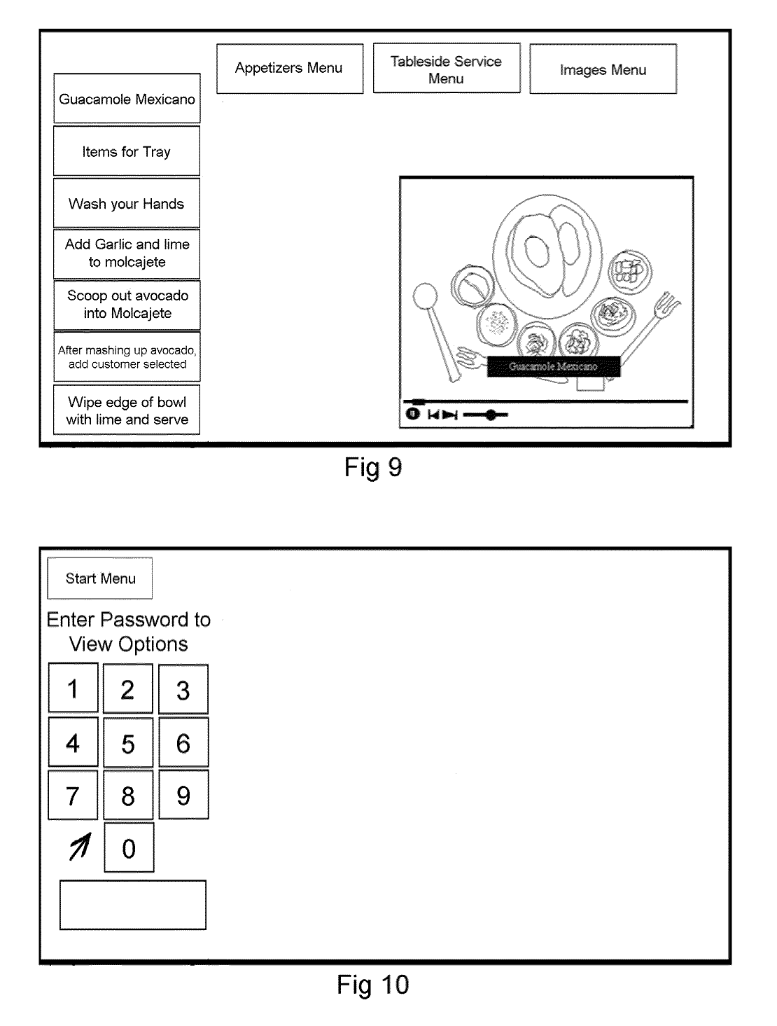

The disclosed invention is a computerized training tool to be used for various industries, including but not limited to retail, health care, hospitality, and restaurants. The invention comprises a terminal 10 with a CPU, storage means such as memory or a hard drive, video screen 14 and input means, such as but not limited to a keyboard, mouse, touch screen 18, and/or voice activation. The terminal 10 may also have an audio output 22. In addition, a slot for an employees ID badge may be located on the terminal to allow an employee to log on to the terminal. Of course in other embodiments, the employee may simply enter in his name, or employee number to log on to the terminal. Number or letter passwords may be in use for management to access, update, and review all items the software deals with. The terminal may be a stand alone unit, or may be in communication with a server 1, other terminals 10, and/or a desktop or portable computer 2, and/or a LAN or Internet based server. Training videos, quizzes, and other training information may be shown on the video screen. The invention may also have some additional features, such as “markers” that allow the viewer to go directly to the specific subject of interest and to replay the specific subject of interest as desired, and a management training tool that allows management to keep track of whether an employee has viewed the video, what level of learning he achieved (through the automated training testing score, analysis, evaluation, and reporting), how many times a person has voluntarily and upon management request reviewed videos or “chapters” (delineated by markers), and further will allow a manager to set up a module that will automatically step an employee through the videos or chapters for which a manager identifies retraining is necessary for an employee, and will track the frequency of voluntary and required videos and chapters reviews. Also, the system includes a method that allows various language audio files to be in sync with the master English audio file so the video files are completely interchangeable among a plurality of languages. The system normally includes video and audio files created specifically for the trainee's work organization. The system also allows for training schedules to be created and maintained for personnel. The system will then automatically notify the employee and/or managers at appropriate times to ensure that the employee engages in the training and reports on the extent of learning achieved by the training to those persons identified to the system as requiring such reports and analyze and evaluate the learning achieved in comparison with others. The system allows for checking to determine the subjects of training utilized in the past by any one person and level of competency achieved as determined by the automated testing. The system allows for checking to determine for any one subject, who has received past training including competency achieved. Markers are shown in FIG. 9.

Referring now to FIG. 2, is a screen capture of one example of an initial startup application screen that would be visible on the video screen 14 of the terminal 10 is shown for a restaurant embodiment. From here, the user can go to any one of about 15 menus (or more categories easily added). The 15 menus being, in one embodiment: server menu, food menu, busboy guide, cook menu, training menu, table side service, hostess guide, bartender guide, prep procedures, safety, employee evaluations (manager status required), manager review (manager status required), plate matching game, existing employee quiz login, new employee login creating. The food menu may break the food items into about 12 categories. However, more or fewer categories may be used depending on the need.

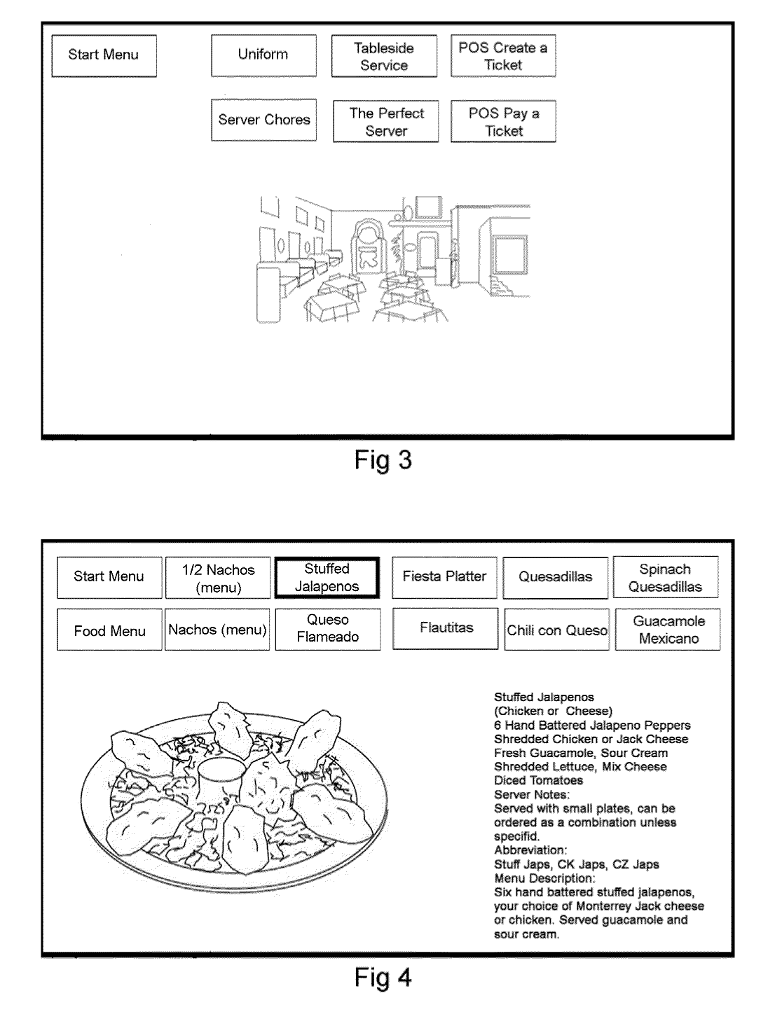

FIG. 3 is a screen capture of an example of a server page (which may be displayed when the server button in FIG. 2 is selected). The server page has a “Start Menu” button, that allows one to go back to the screen shown in FIG. 2. The server page has 6 videos that may be selected for training of the server, each video may be accessed by selecting one of the 6 buttons shown. In this embodiment the buttons are: 1. Uniform, 2. Tableside Services; 3. Point of Sale (POS) Create a Ticket; 4. Server Chores; 5. The Perfect Server; and 6 POS Pay a ticket. Of course other embodiments may have more or fewer videos (and associated video buttons on the screen) available for training the server. In addition, the buttons may have submenus, to provide even more video selections.

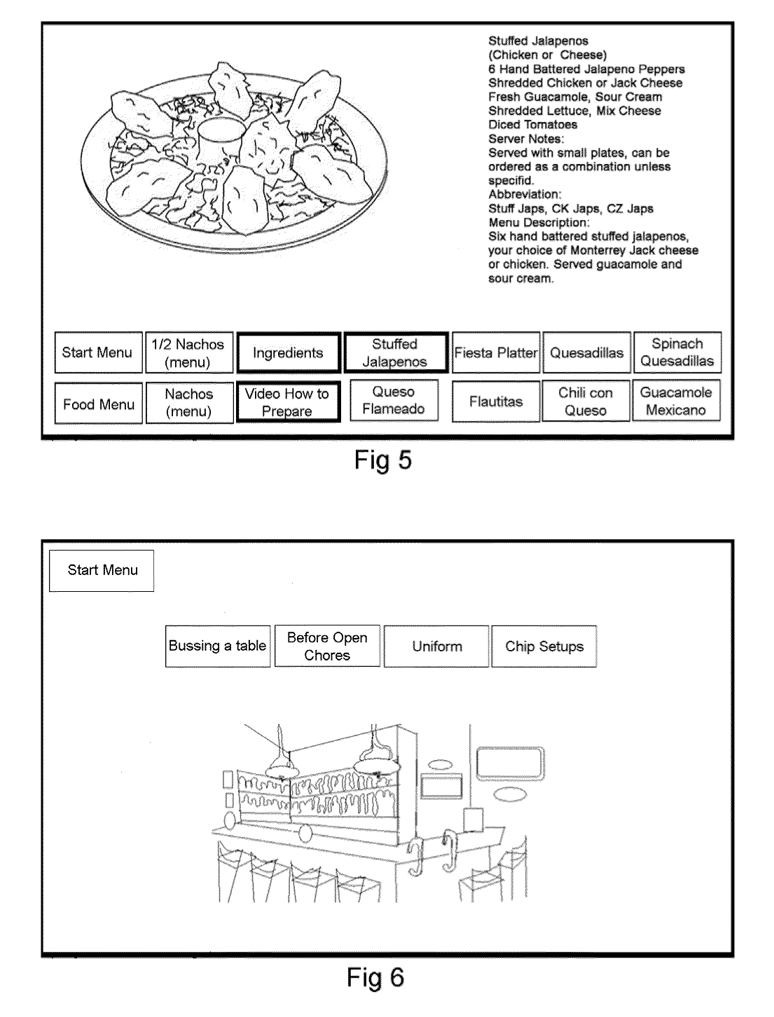

FIG. 4 is a screen capture of an appetizer screen that is shown when the “Food Menu” button from the screen shown in FIG. 2 is selected, and then an “Appetizer” button is selected (not shown). Further, if the “Stuffed Jalapenos” button is selected, a photograph of how the stuffed jalapenos is served is shown, plus a written description of the ingredients and other information about stuffed jalapenos is shown, see FIG. 5. In FIG. 5 there is a photograph showing how the dish is served; a written description of the ingredients for the Fiesta Platter is shown, as well as other pertinent information regarding the dish. An option is also available to watch a video in Spanish, English or any other suitable language regarding how to prepare and/or serve this plate.

FIG. 6 is a screen capture of an example of a busboy guide page (which may be displayed when the “busboy guide” button FIG. 2 is selected). The buttons shown, “bussing a table”, “before open chores”, “uniform”, “chip setups” are examples of videos a busboy may select, to assist in training the busboy. Thus a busboy may select any of the buttons “bussing a table”, “before open chores”, “uniform”, “chip setups”; and watch a video on the topic of the button selected.

-1 and 3-2 show the Server menu and video options. If the “Cook” button is selected from the screen shot shown in FIG. 2, then a similar screen shown in FIG. 6 will display, showing the different videos a Cook may select to watch in order to be trained in the various aspects of his or her job. In addition, photographs of all or some of the dishes that a cook will be responsible for making may be displayed, along with detailed recipes, preparation and serving guides. The information on this screen may be password protected so only cooks and managers can view. Of course, one of ordinary skill in the art will recognize that any of the screens may be password protected depending on the needs of the end user.

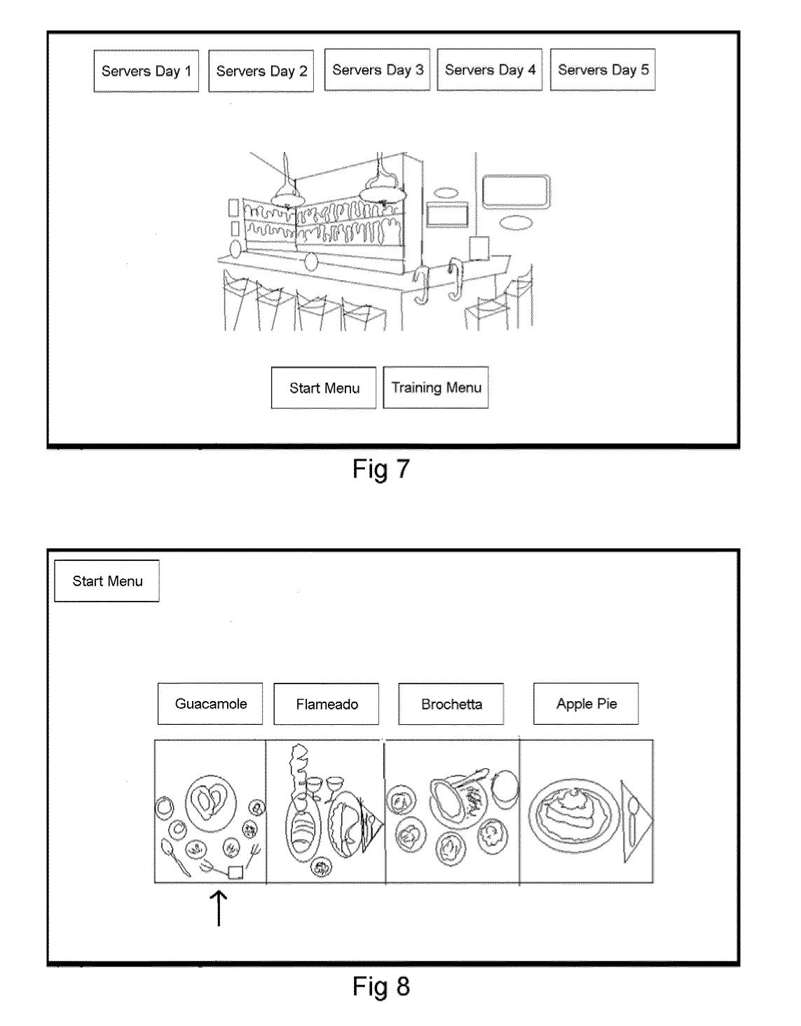

FIG. 7 is a screen capture of the training screen that is shown when the “Training” button from the screen shown in FIG. 2 is selected. The various buttons shown on the screen, are listed in this embodiment as “Servers Day 1”, “Servers Day 2”, “Servers Day 3”, “Servers Day 4, and “Servers Day 5”. If a user selects the Servers Day 1 button shown on this screen, then the user will be given the option to select pictures and videos associated with what they need to learn on or by their first day of employment. If a user selects the Servers Day 2 button shown on this screen, then the user will be given the option to select pictures and videos associated with what they need to learn on or by their second day of employment, and so on. Further, if the user selects the “Training Menu” button, the user may see the progress of their training, and what training videos and screens they still need to watch, for example.

FIG. 8 is a screen capture showing a start page for the Table side service option. In this screen capture, the user has the choice of several videos he can select to watch. In FIG. 8 the user is about to select the Guacamole video. FIG. 9 is a screen capture of the Guacamole Mexicano video, which will show a server how to serve and/or prepare the guacamole mexicano dish at the diner's table. There are items listed on the left of this screen capture (shown in FIG. 9) that are the instant markers that when selected advance the video to any preset marker in this video. The markers are: Guacamole Mexicano, Items for Tray, Wash your hands, Add garlic and lime to mocajete, Scoop out avocado into molcajete, After mashing up avocado-add customer selected, wipe edge of bowl with lime and serve. One of ordinary skill in the art will recognize that other suitable markers may be used with other videos. The markers give the sequential steps on the left, and help the viewer go to any step of this video. This allows for video learning and re-learning to be fast and effective. The videos may come in English, Spanish and/or any other suitable language. All the cook preparation and menu items may be also be in English, Spanish and/or any other suitable language. The idea is to make the video quick and easy to use as a reference for continual training (not just initial training) in multiple locations throughout the restaurant, and for new employee training.

Referring back to FIG. 2, the startup application screen shows a button labeled “Employee Evaluations”. Instead of being password protected, users may be assigned at employee setup the “manager status” as true or false, if they are assigned “manager status true” then they have access to the “Manager review” section automatically. This button may display a number above that shows how many if any employee evaluations are due to be completed. In this case, the number “3” is shown, indicating that 3 employee evaluations need to be completed. The disclosed system keeps track of the employee start dates and (if desired) can accurately tell when the correct year evaluation, or monthly evaluation is due.

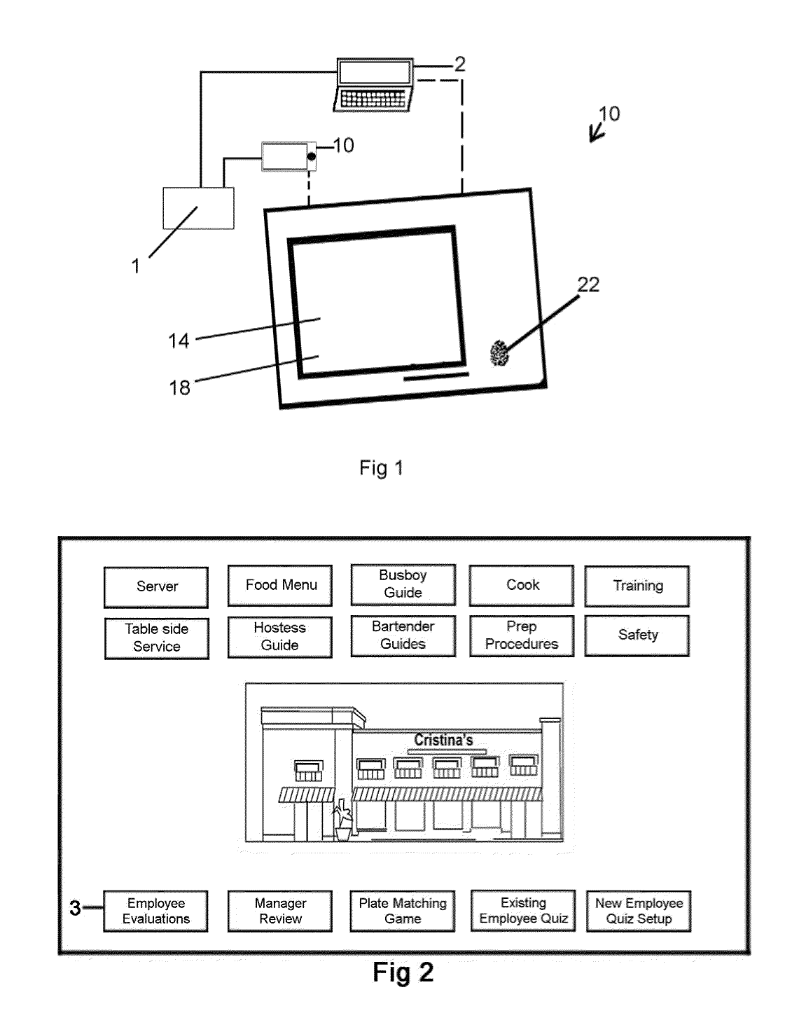

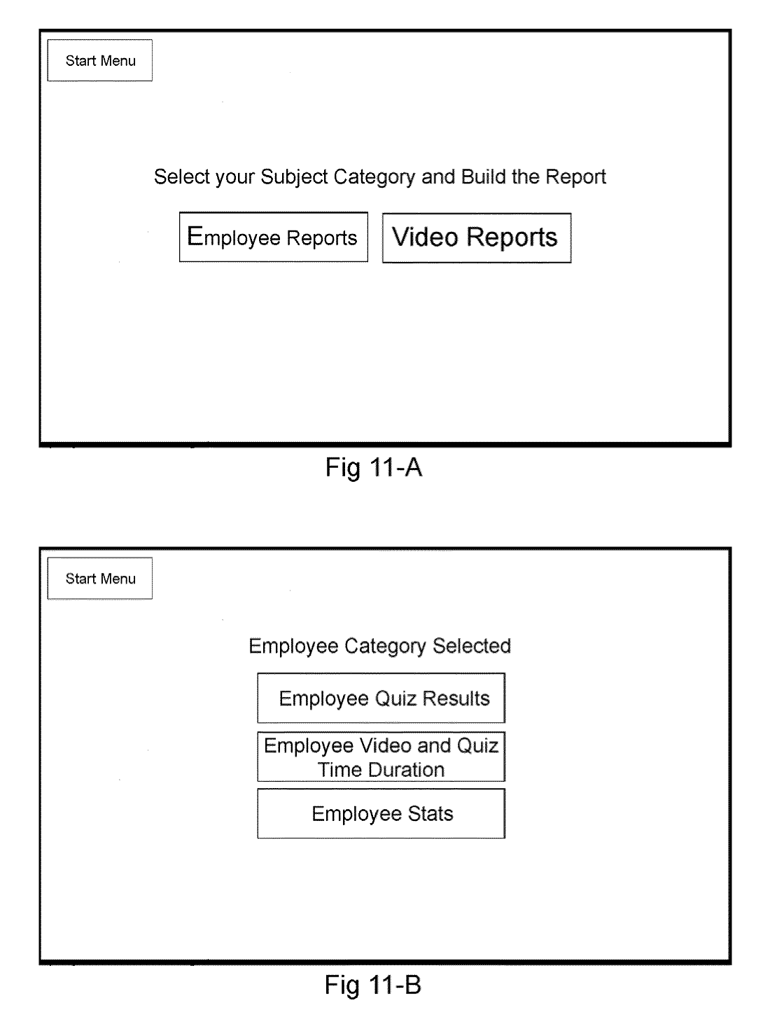

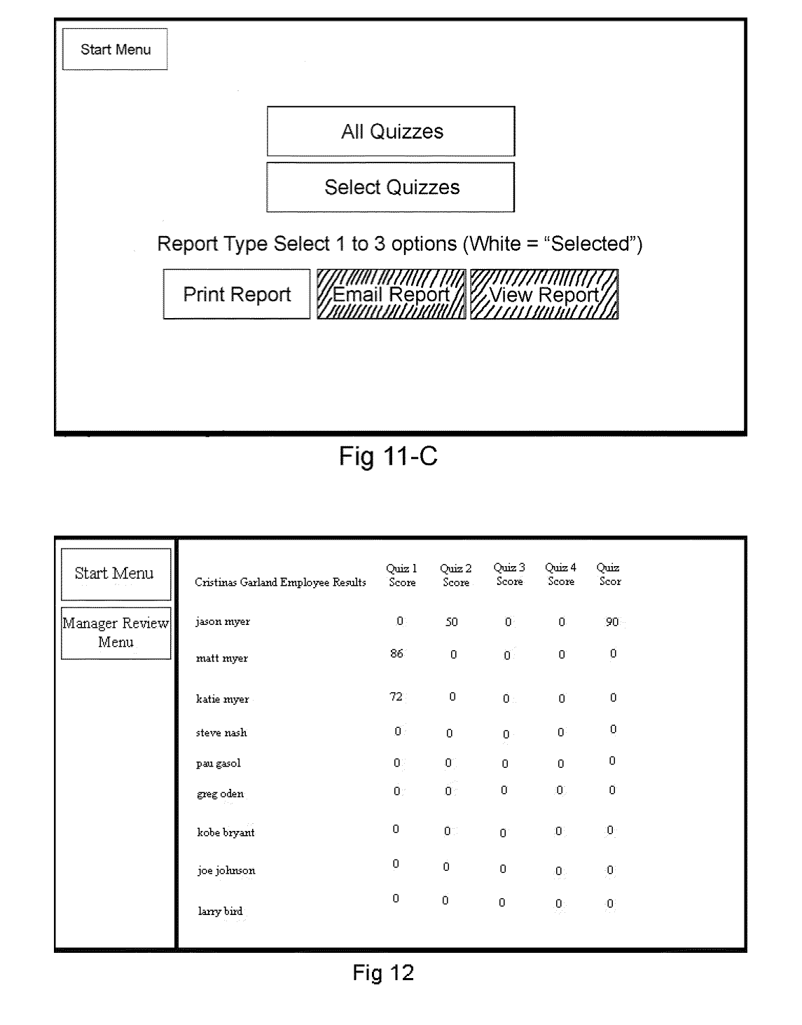

FIG. 2 also shows a button for “Manager Review”. If the “Manager Review” button is selected, then FIG. 10 shows a screen capture of the screen that comes up. This page also is may be “manager status protected”. If “manager status=true”, then other report options become visible, as shown in FIGS. 11-1, 11-2, and 11-3. FIG. 12 shows a screen shot of a report of all employees and their current test scores, if the “Employee Quiz Report to Print” button was selected in FIG. 11. The manager review/admin section will also include extensive tracking of what questions were missed the most, the ability of the manager to modify/delete, or add questions and answers to the quizzes. Also this section will track system use by all employees and managers helping to see who is doing what, and who is not. Reports have the option to be printed out/viewed/and emailed and if emailed, then the system may be configured to automatically email on a schedule set by the organization.

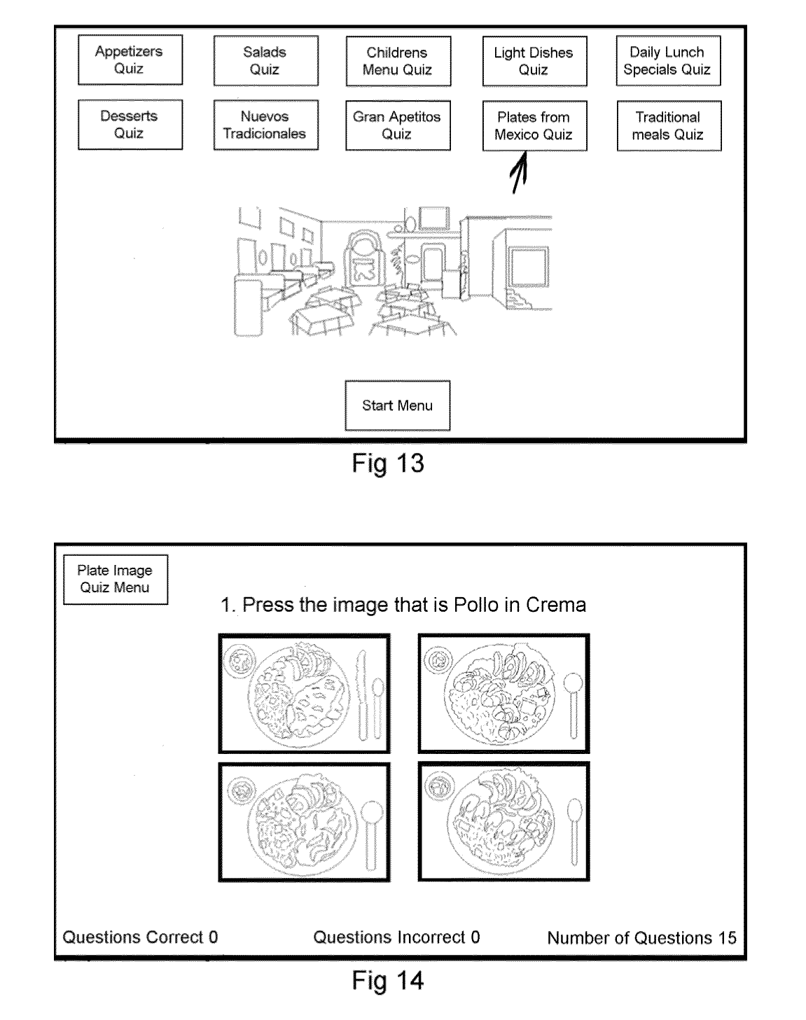

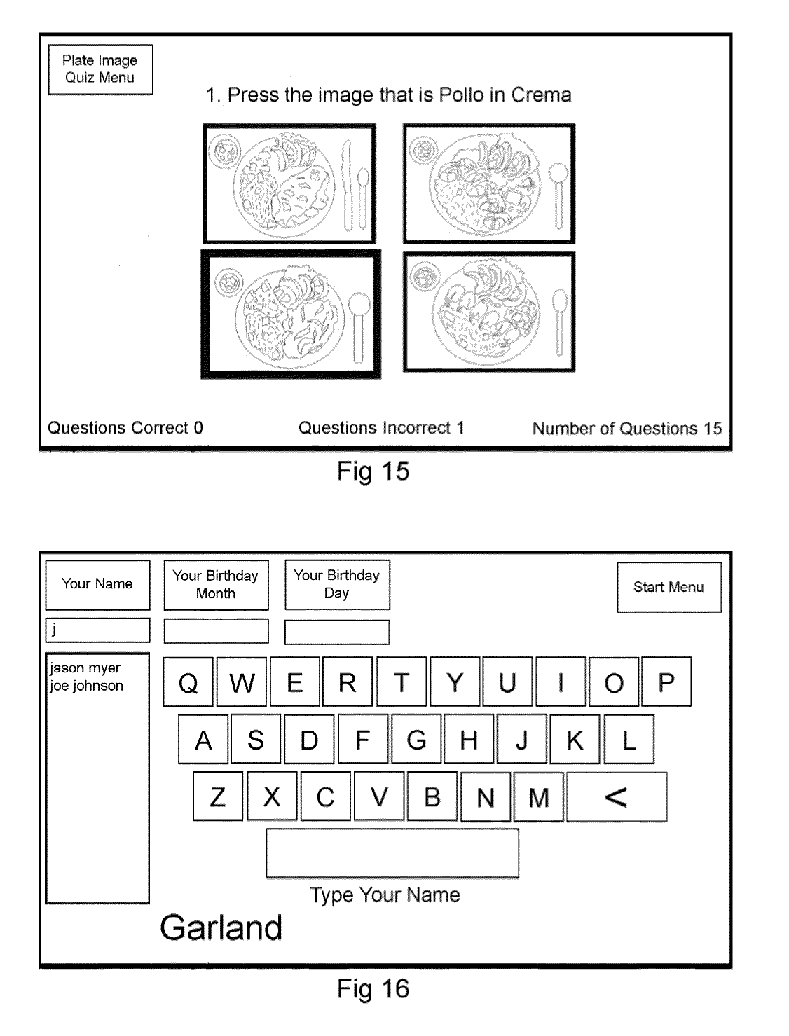

FIG. 2 shows a button listed as “Plate Matching Game”. The Plate Matching Game is a game-like quiz for employees to take. FIG. 13 shows a screen capture of a screen that may come up with the “Plate Matching Game” button is selected. FIG. 13 shows the categories of quizzes on 11 buttons in this screen. FIG. 14 shows the “Plates de Mexico” quiz. This quiz, like other quizzes shown on FIG. 13, uses an interactive method to help teach employees plates, not just grade them on their current knowledge. The user simply presses the image that is the correct answer for the question above. If the user is correct, the total number of correct answers is shown in the Questions Correct label near the bottom of the screen in FIG. 14, and the next question with images is displayed. If the user is incorrect, then the correct image is highlighted as shown in the FIG. 15, where the lower left hand image is highlighted and must be selected by the user using a pointer, for the next question to begin. In addition the number of questions answered incorrectly is shown in the lower middle of the screen. This method of quizzing promotes learning by the employee.

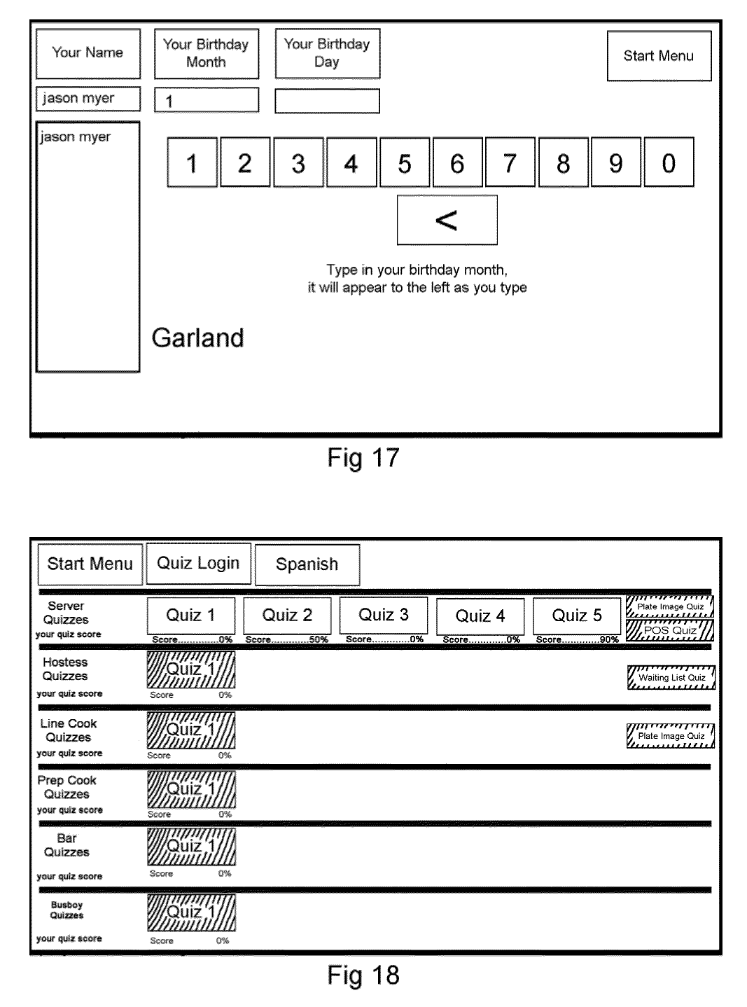

FIG. 2 shows a button labeled “Existing Employee Quiz”. When a user presses this option and then logs in on the screen shown in FIG. 16, the user may enter his name, birthday month, and birthday day. The system (for improved accuracy and speed) shows any matching names after each letter for the name is entered. If only one name is left, the user can skip finishing entering in the rest of the spelling of their name and continue to the birthday month and birthday day entry. FIG. 17 shows a screen capture of the month entering and birthday entering screen. The quiz results may be stored and organized by employee. The quizzes may be in English, Spanish, or any other suitable language. The quizzes and quiz results will be able to be switched between any two or more languages to allow a quiz participant of any language background to take the quiz, and/or allows for a manager of any language background to review the quiz results. For instance if an employee takes the quiz in Spanish, a manager can review the quiz results in English. FIG. 18 shows a screen capture of a successful existing employee login and the screen shows any current scores that employee currently has recorded. From here, the user can go and take any quiz that has not been greyed out (greyed out buttons are shown with the hatching). The greyed out quizzes may be quizzes for a different job type and may not apply to the current user for this example.

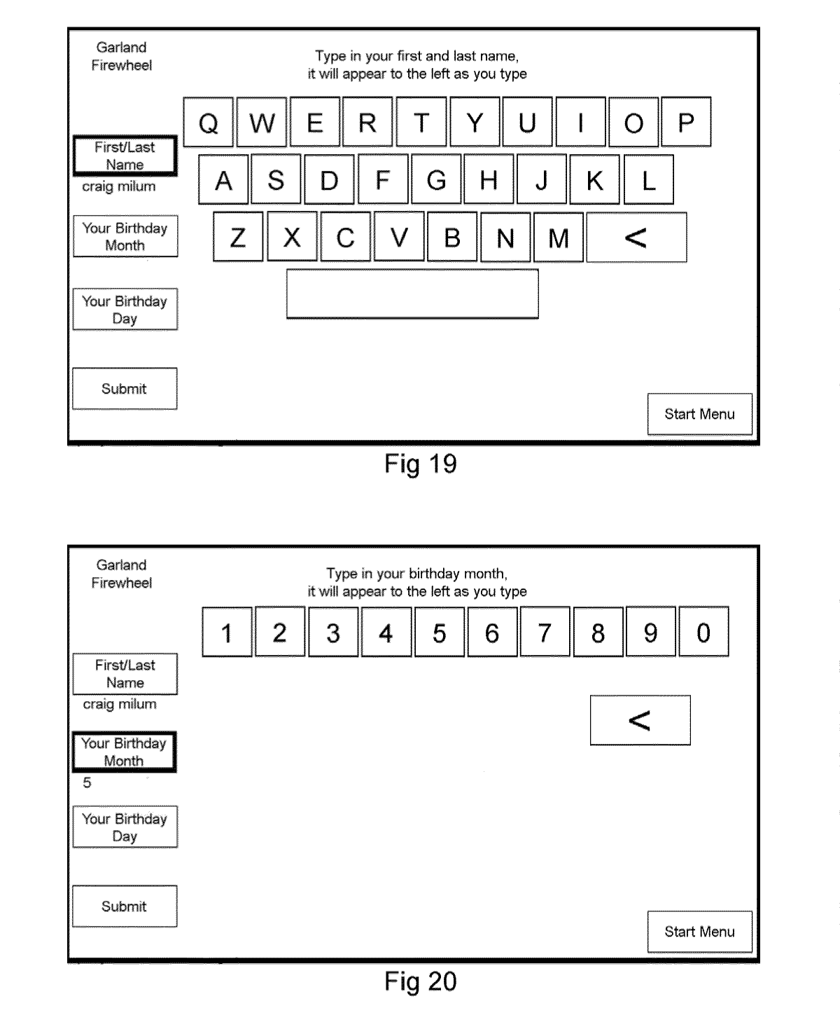

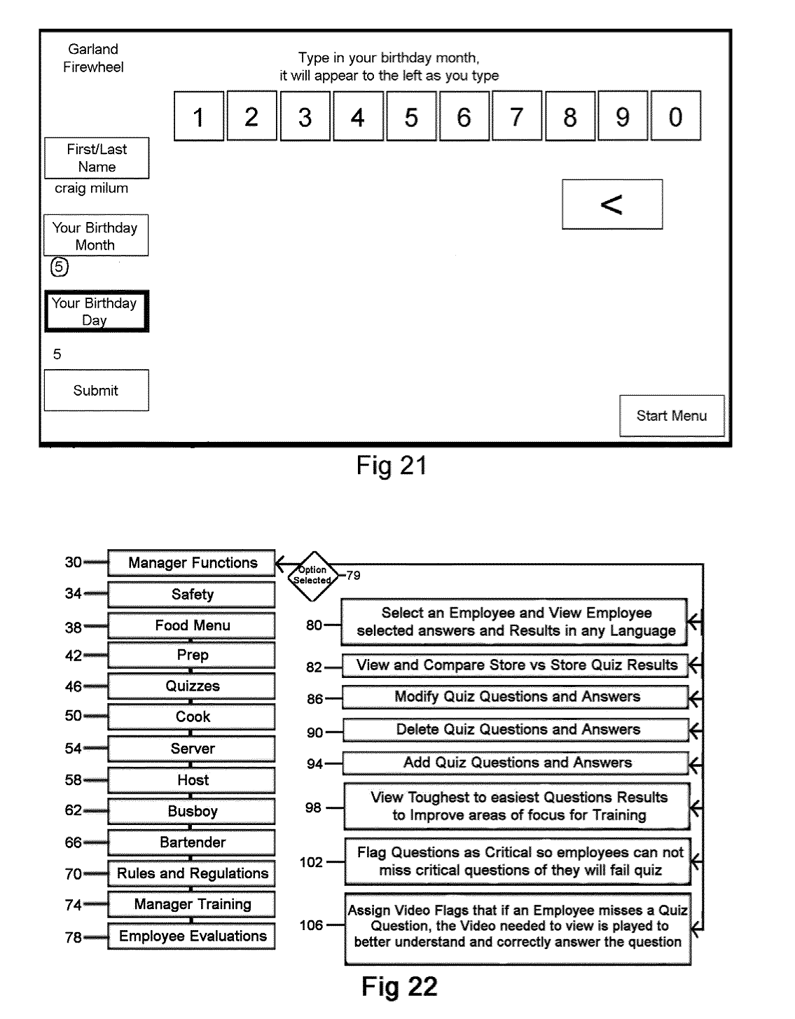

FIG. 2 shows a “New Employee Quiz Setup” button. When the New Employee Quiz Setup button is selected, then the screen represented by the screen capture shown in FIG. 19 is shown. The New Employee Quiz Setup screen allows one to create a new employee login to be used when taking and recording quizzes by the Automated Training system. FIG. 13-2 shows the “First/Last Name” button highlighted, meaning this is the process to be currently completed. Then the user will press the “your birthday month” button and enter in his/her birthday month using the numbers on the touchscreen keypad, see FIG. 20. Then the user presses the “your birthday day” button, see FIG. 21, and enters in their birthday day then presses the “submit” button on the bottom left. The user is taken to the start page (see FIG. 2) after pressing the “submit” button and then the user can instantly go to the existing employee quiz by pressing the “Existing Employee Quiz”.

The quizzes are designed for ease of use, and ease of accessing the employee's skills. The employee simply reads the question in the language of their choice, then selects their choice for the right answer. The system will continue to the next question if the correct answer is selected. If the wrong answer is selected, the correct answer has a 10% larger hidden box behind that contains the correct letter answer. The box becomes a different color than the background, and forces the user taking the quiz to realize they answered incorrectly and to press the correct answer to continue. This creates learning in quizzes where in the past, quizzes were only used for grading the level of an employee's knowledge. This extra learning makes our system more interactive and is conducive to greater learning. The employee still gets the same score on the quiz as they would've without this added (optional) feature, but they continue to learn. Currently there are 3 types of quizzes with more in development. The first is multiple choice, the second is True/False, the third is select the correct image in which 2 to 4 images are shown at once and the employee must select the correct image to correctly answer the question.

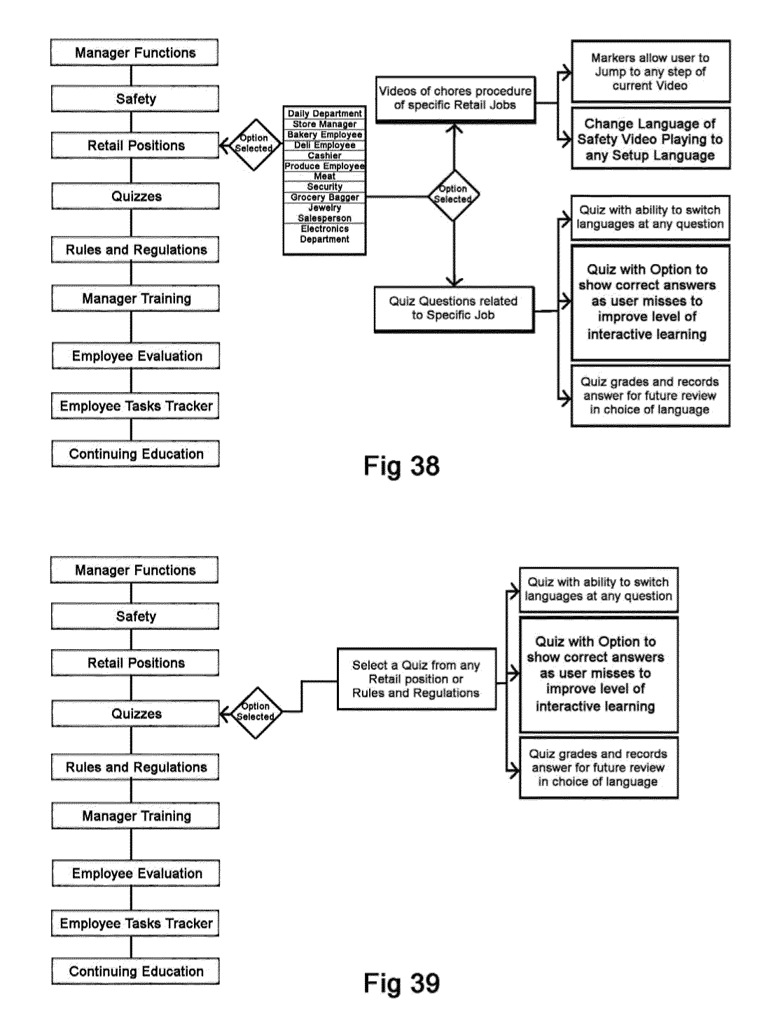

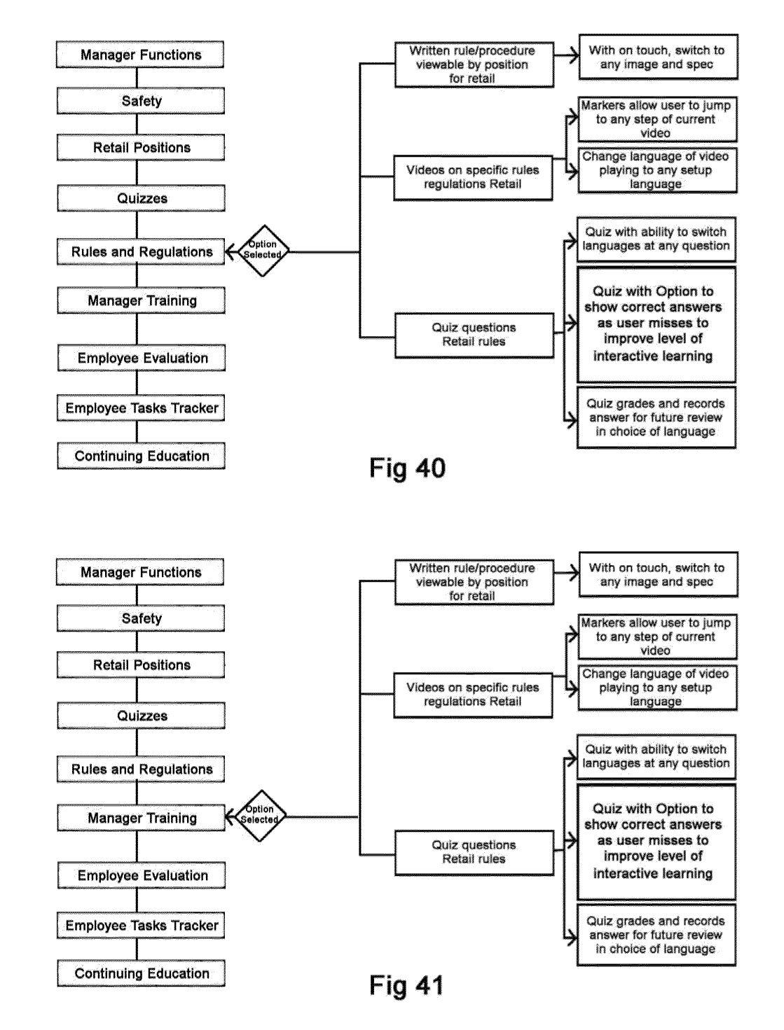

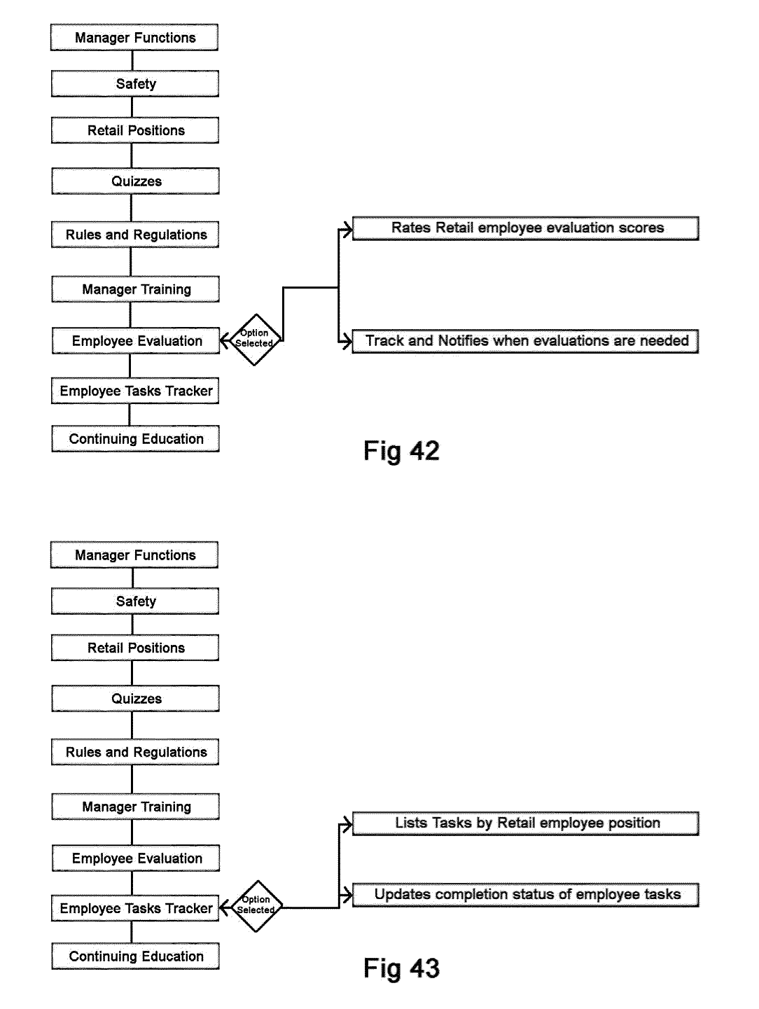

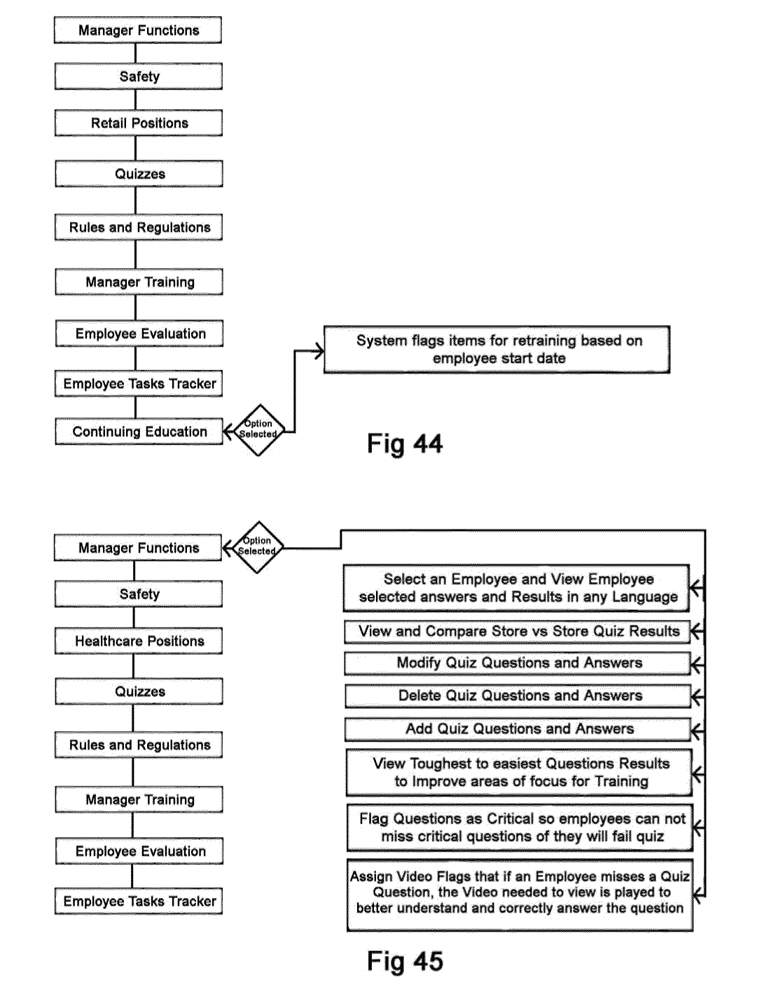

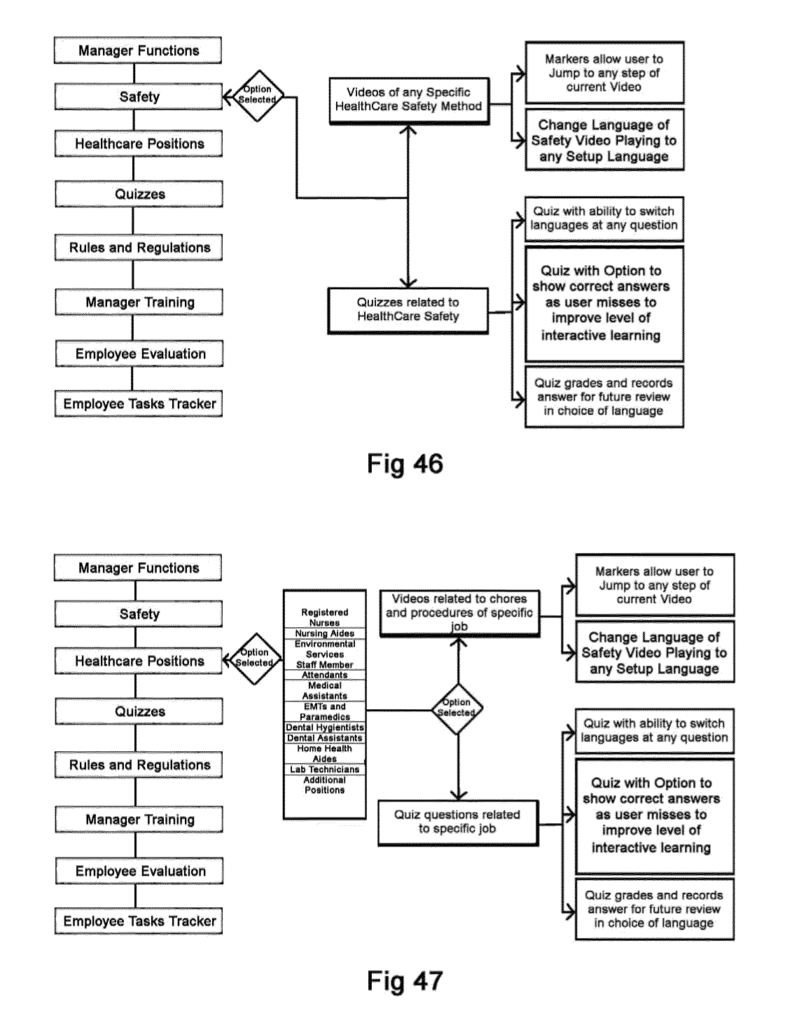

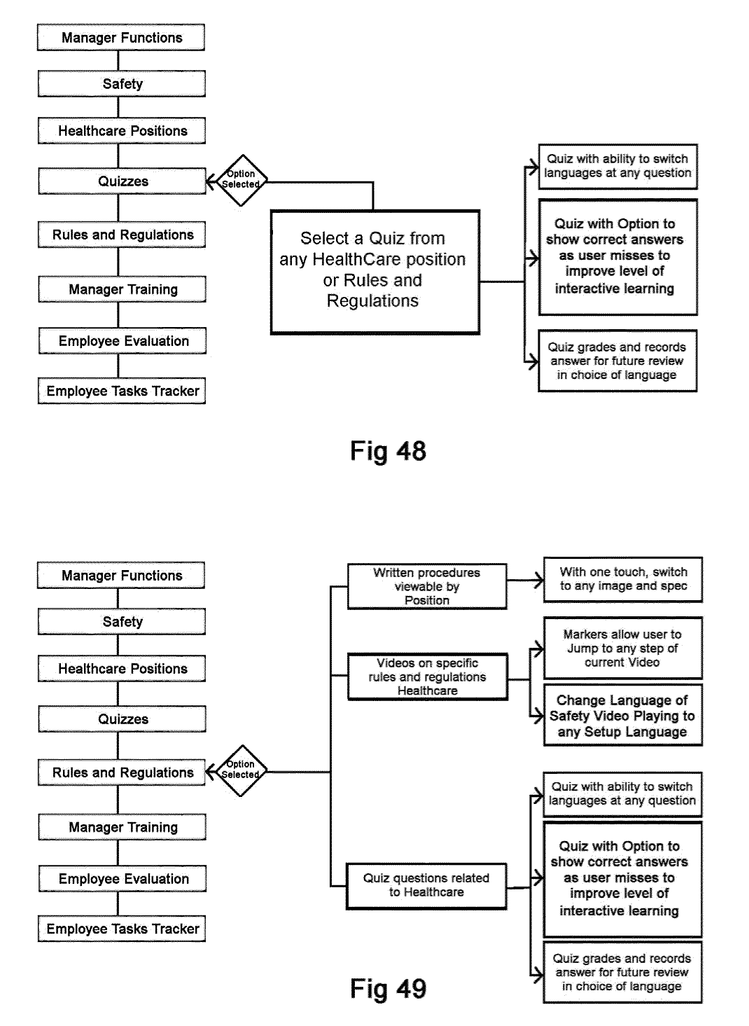

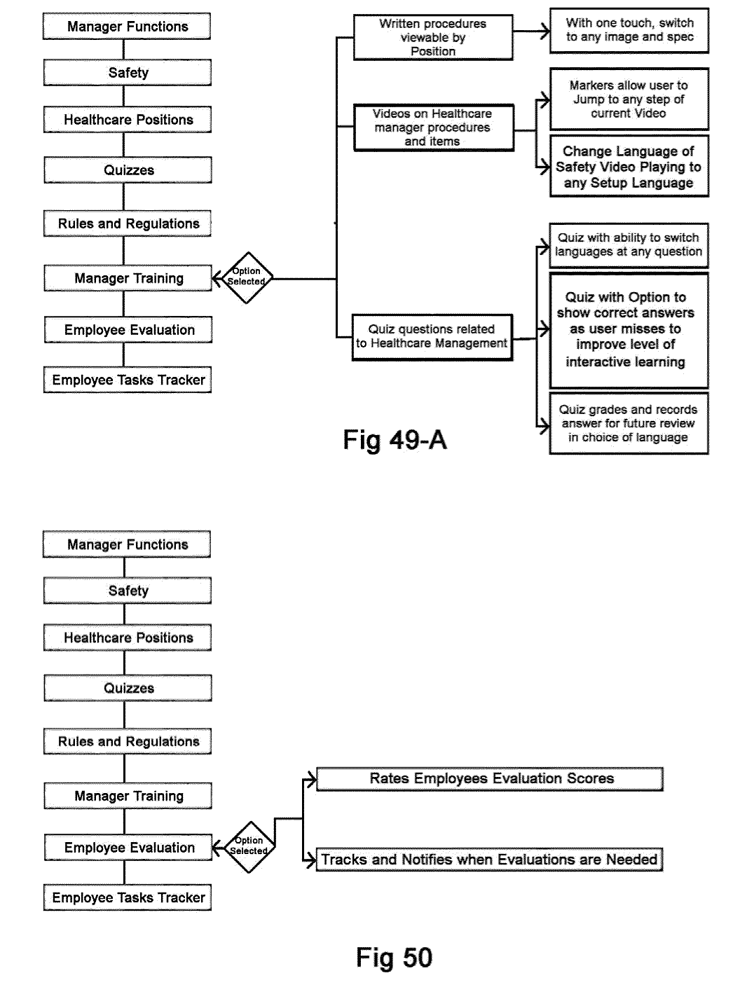

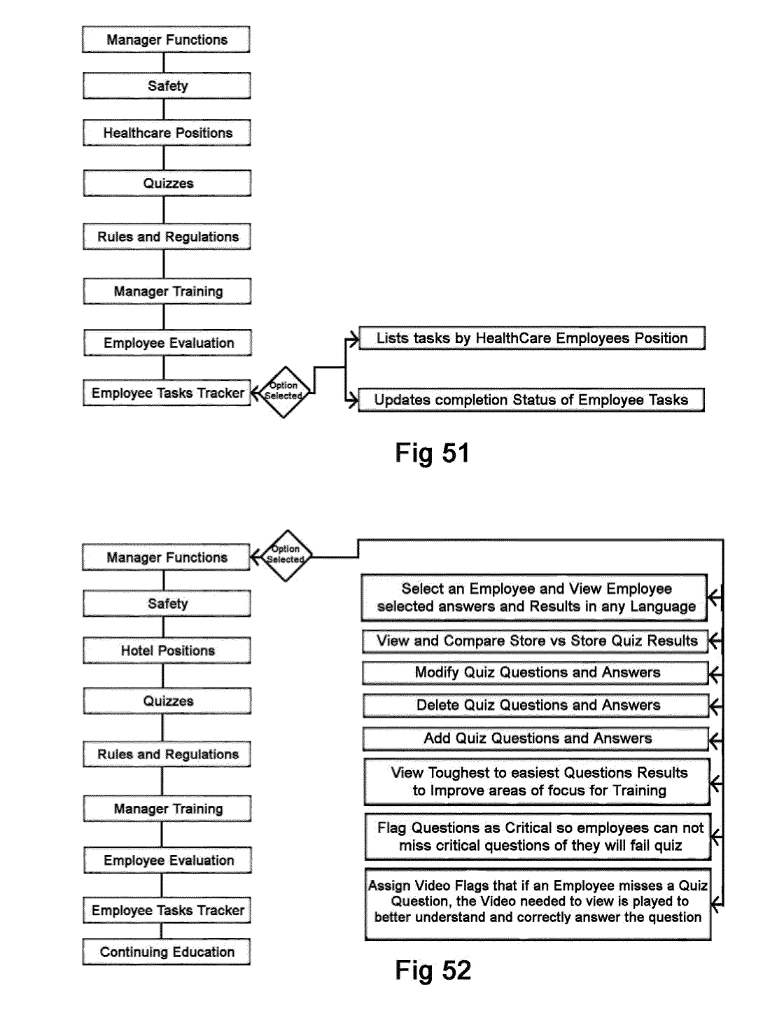

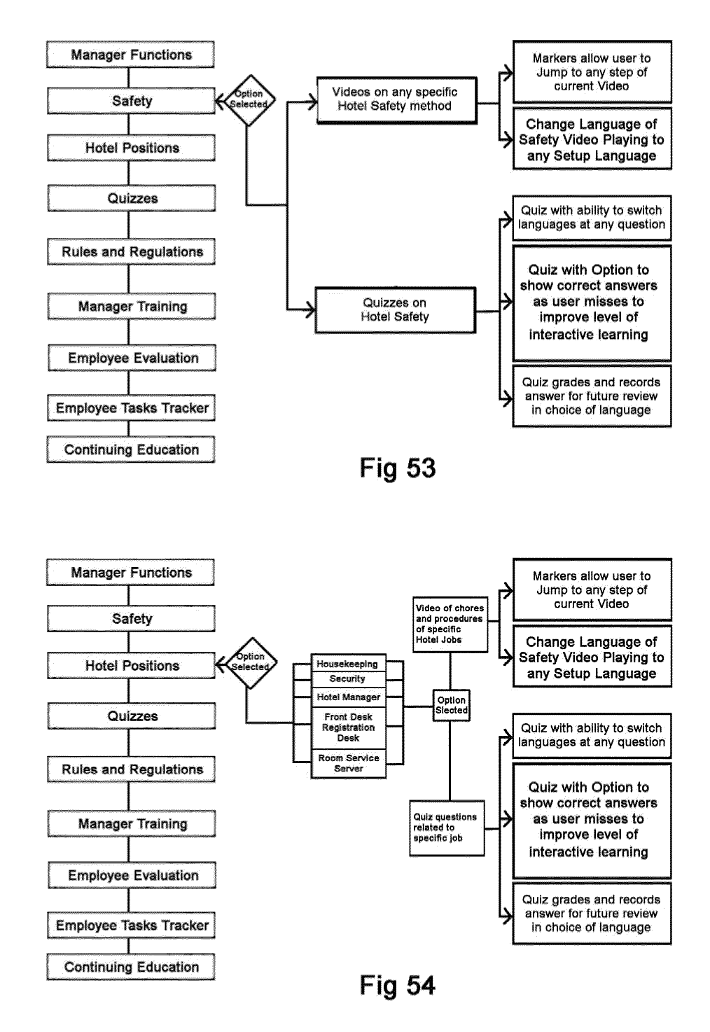

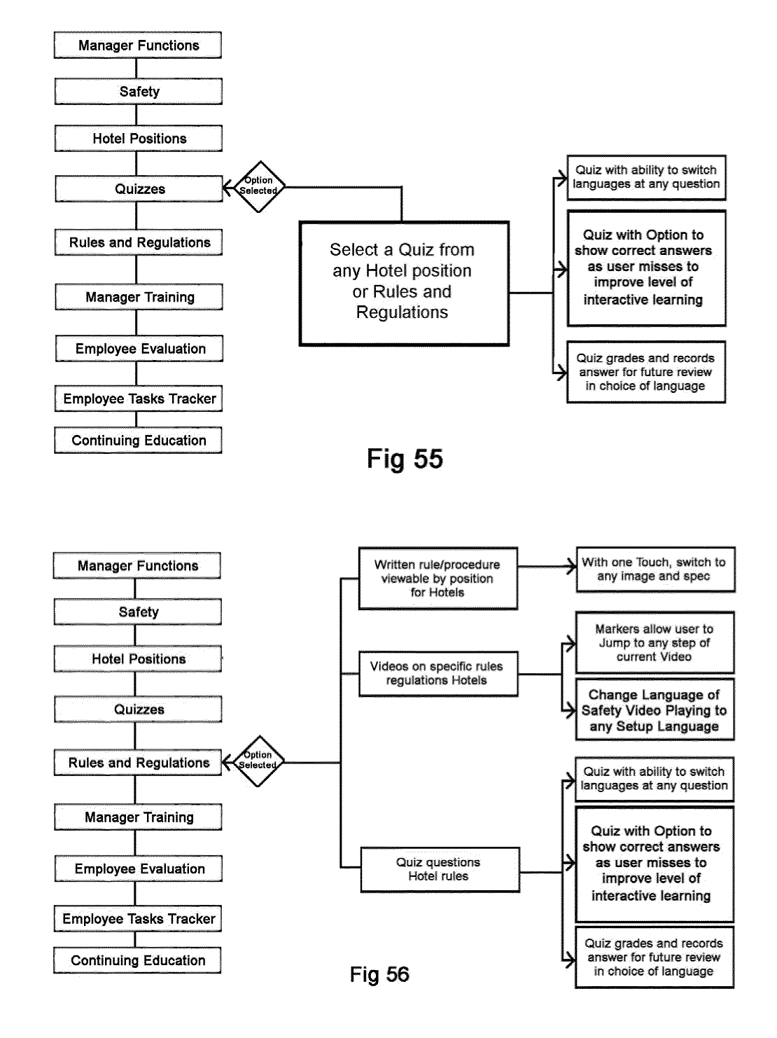

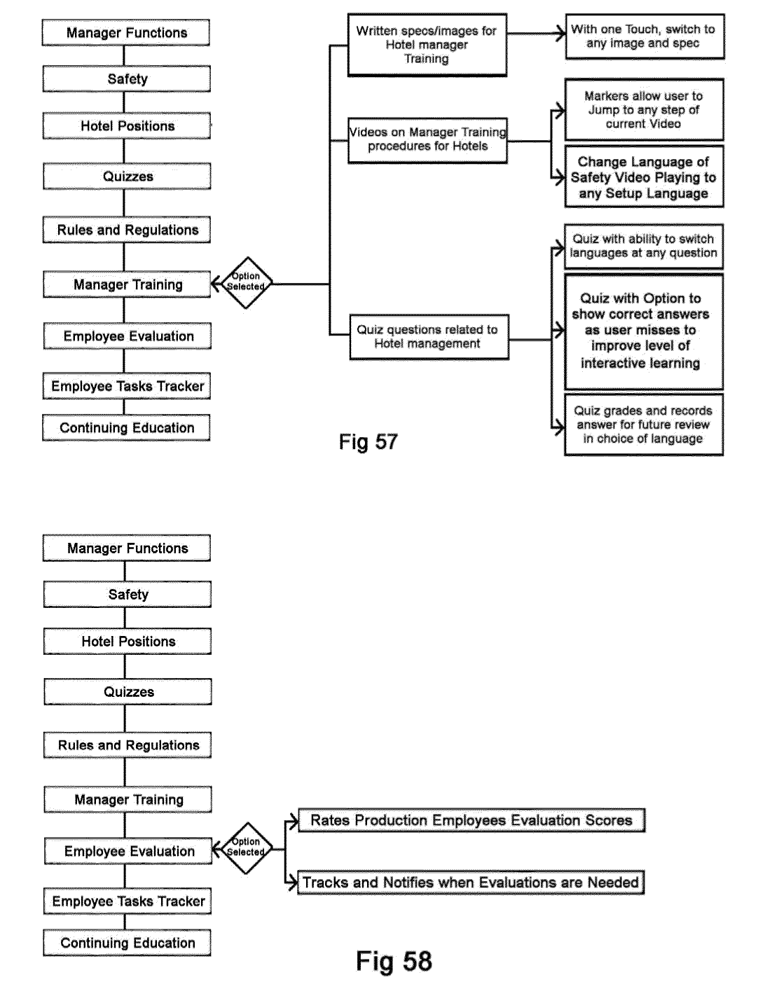

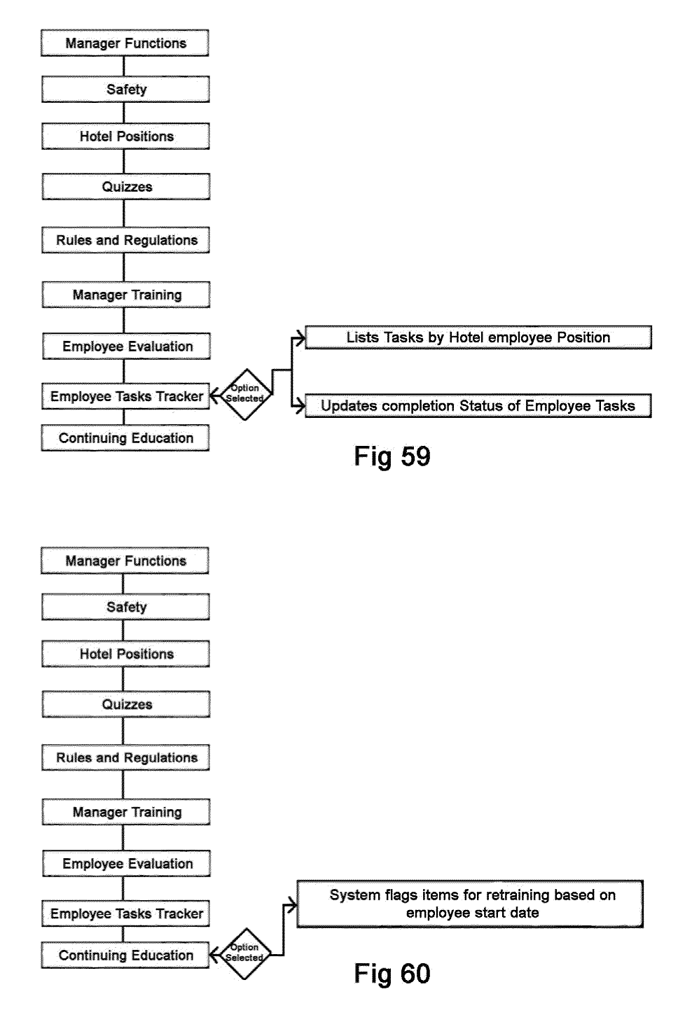

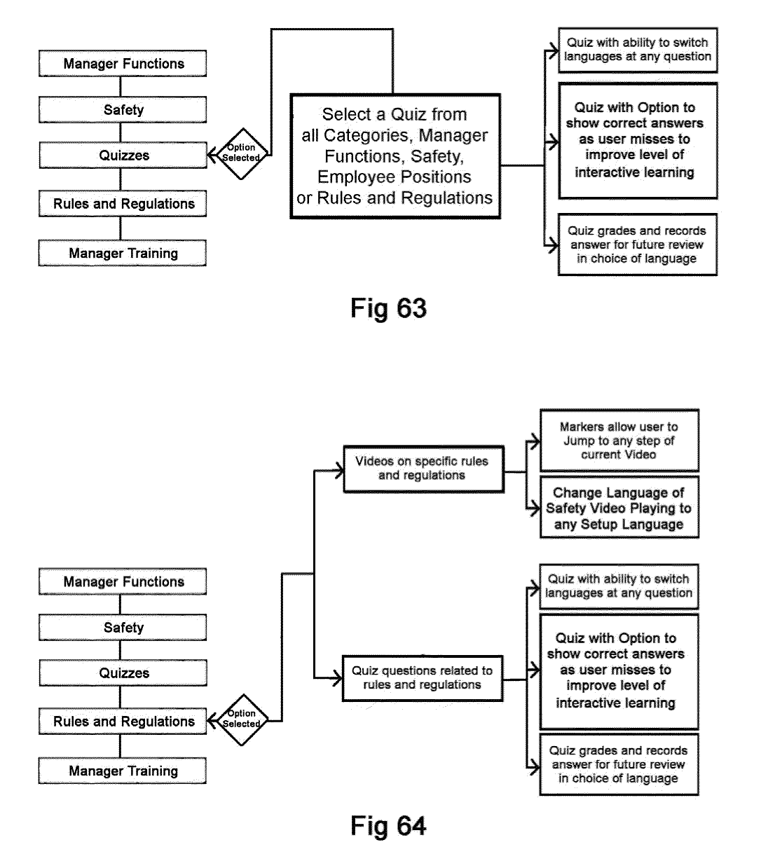

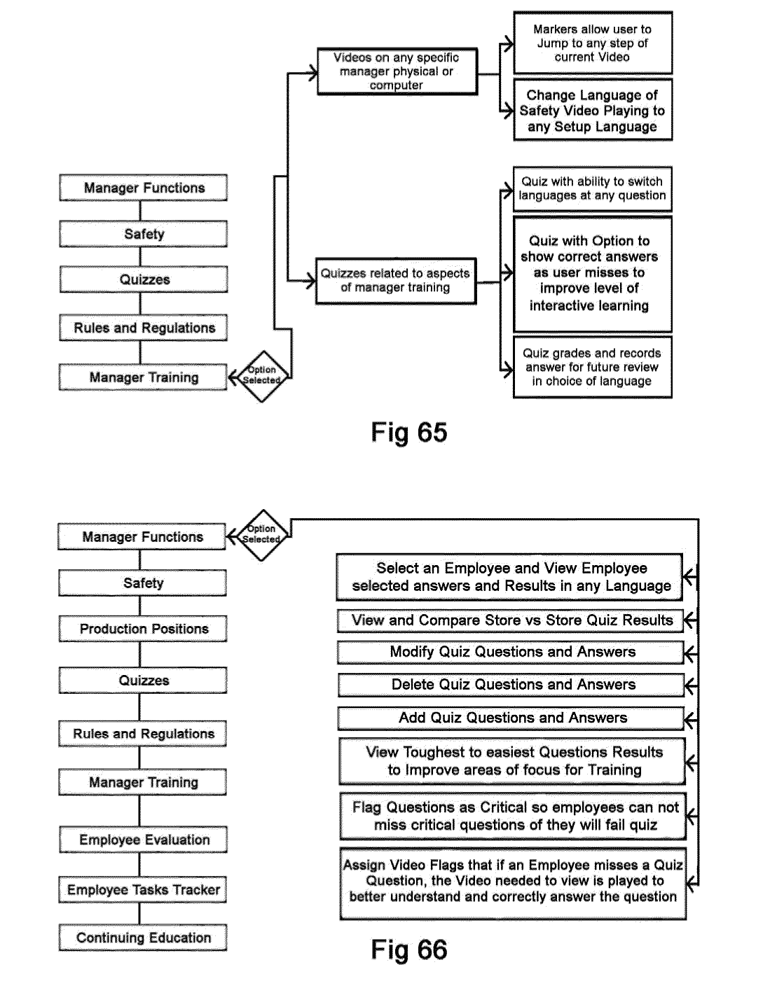

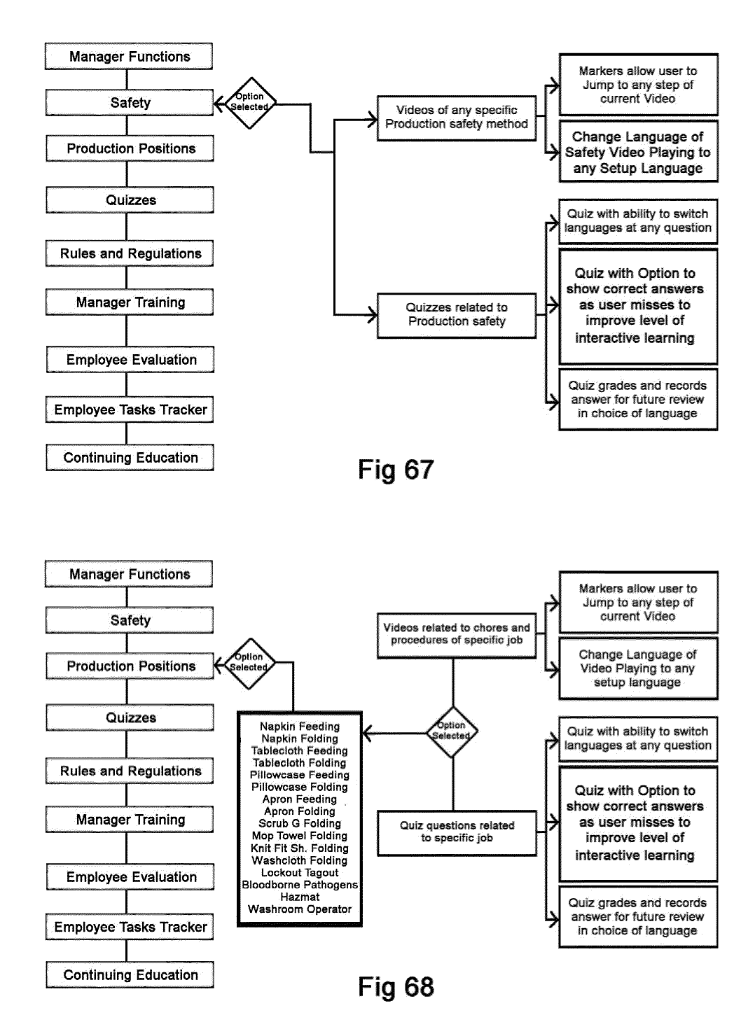

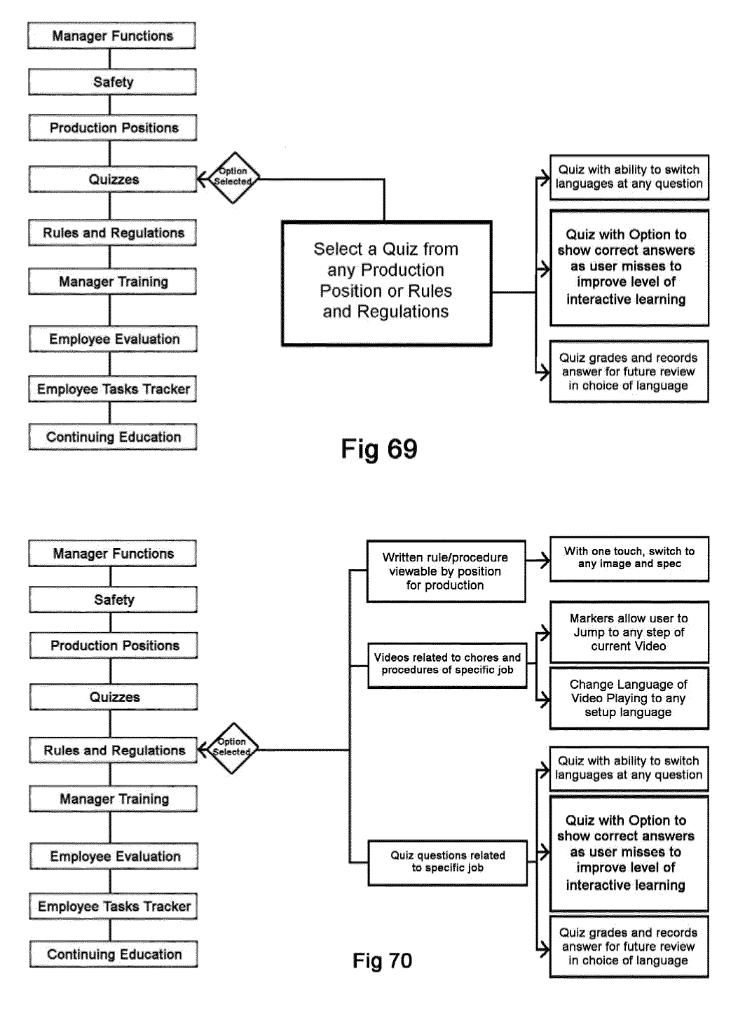

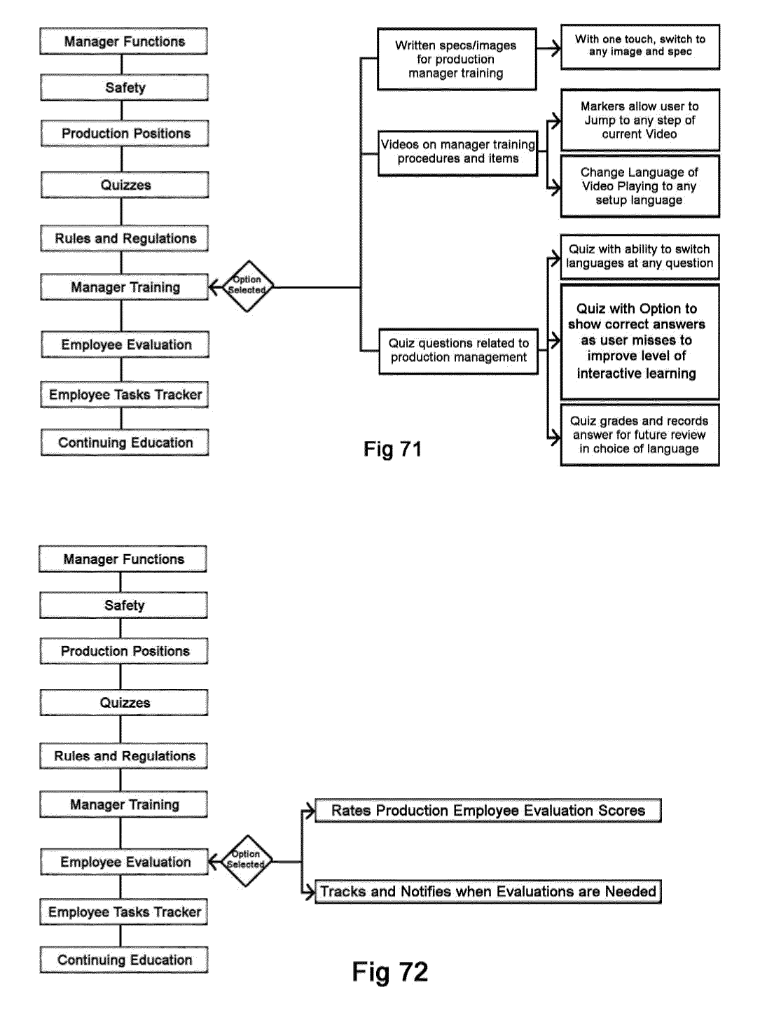

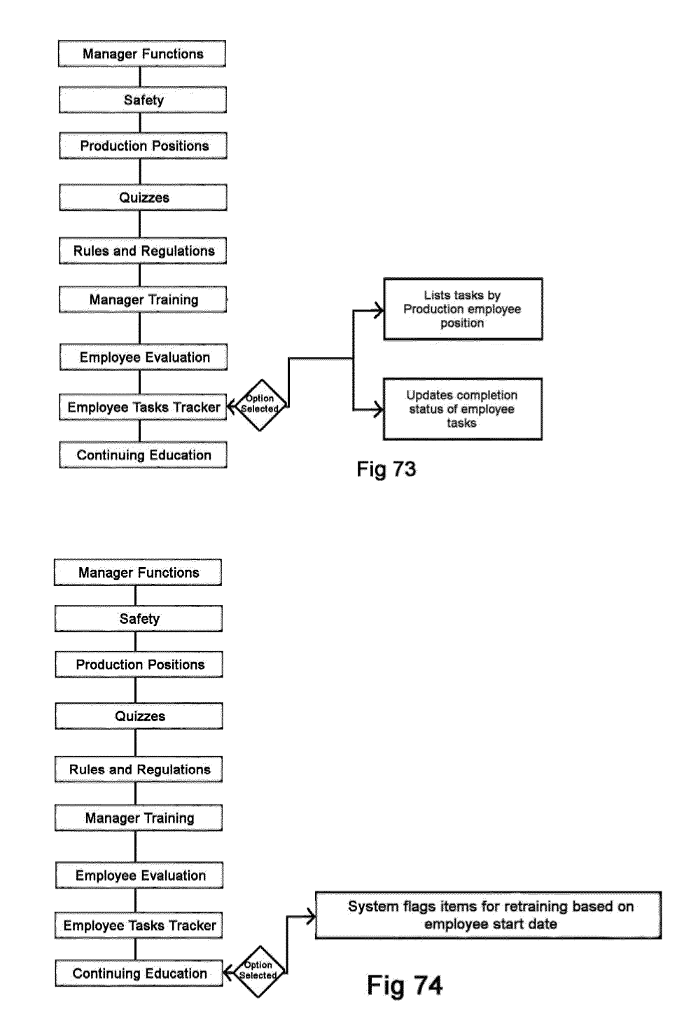

FIG. 22 is a diagrammatic illustration of one embodiment of the training system for use in a Restaurant embodiment. The embodiments disclosed by the diagrammatic illustrations shown in FIGS. 22 through 74 may be realized through databases and/or computer code and stored in a storage means located in a server 1 which is in communication with the terminals, or on a storage means located in the terminal 10, or on a computer 2 in communication with the terminals 10. FIG. 22 shows a column of possible modules in the disclosed system on the left hand side. These modules may be a “Manager Functions” module 30, a “Safety” module 34, a “Food Menu” module 38, a “Prep” module 42, a “Quizzes” module 46, a “Cook” module 50, a “Server” module 54, a “Host” module 58, a “Busboy” module 62, a “Bartender” module 66, a “Rules and Regulations” module 70, a “Manager Training” module 74, and an “Employee Evaluations” module 78. A user may select any of the modules. The option selection diamond 79 represents which of the modules the user chooses. The option selection diamond 79 may be an interface between the user and the disclosed system, such an interface may be a keyboard, key pad, mouse pointer, touch screen, rollerball, or voice activated. In FIG. 22 the user has selected the Manger Functions module 30. Once the module 30 is chosen, the user has options to proceed with any one or more of a plurality of modules located on the right side of the page. These modules are “Select an Employee and view Employee selected answers and results in any language” 80, “View and compare store vs. store quiz results” 82, “Modify Quiz questions and answers” 86, “Delete Quiz questions and Answers” 90, “Add Quiz questions and answers” 94, “View toughest to easiest questions results to improve areas of focus for training” 98, “Flag questions as critical so employees cannot miss critical questions or they will fail quiz” 102, “Assign video flags that if an employee misses a quiz question, the flag shows what video chapter, as identified by video chapter marker the employee needs to watch to better understand and correctly answer the question, if there is a video” 106.

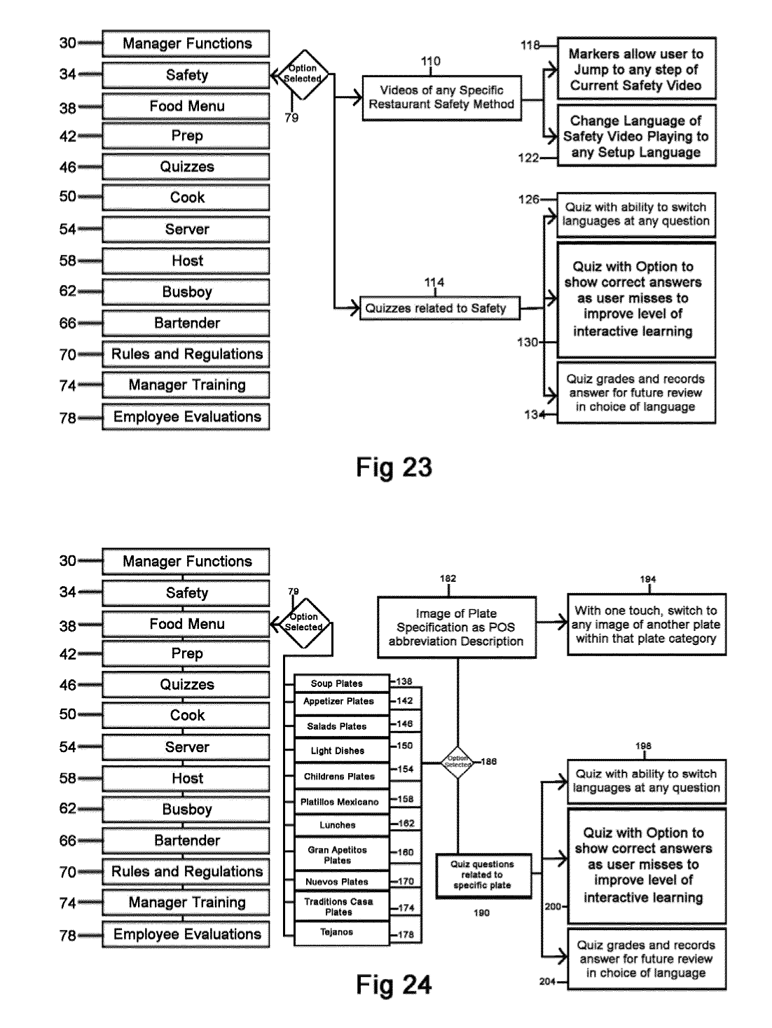

FIG. 23 is a diagrammatic illustration of one embodiment of the training system for use in a Restaurant embodiment, but where the option selection diamond 79 is now moved by the user to select the Safety module 34. Once the Safety module 34 is selected, then the user has the option to select the “Videos of any specific restaurant safety method” module 110, or the “Quizzes related to safety” module 114. If the user selects module 110, then the “Markers allow user to jump to any chapter of current safety video” module 118, and/or the “change language of safety video playing to any available language” module 122, if selected, will activate. Module 118 may have sub-modules, that allow a user to view any of the various videos with respect to the specific restaurant safety method that the user wants to be trained on. If the user selects the 114 module, then the “Quiz with ability to switch languages at any question” module 126, and/or “quiz with option to show correct answers as user misses to improve level of interactive learning” module 130, and/or the “quiz grades and records each answer for future review in choice of language” module 134 will activate for the quiz taken done by the user.

FIG. 24 is a diagrammatic illustration of one embodiment of the training system for use in a Restaurant embodiment, but where the option selection diamond 79 is now moved by the user to select the Food Menu module 38. Once the module 38 is selected, the user has the option to select modules associated with the various menu category items, such as “Soups Plates” 138, “Appetizers Plates” 142, “Salads Plates” 146, “Light Dishes” 150, “Children Plates” 154, “Platillos Mexico” 158, “Lunches” 162, “Gran Apetitos Plates” 166, “Nuevos Traditions Plates” 170, “Traditions Casa Plates” 174, and “Tejanos” 178. Modules 138 through 178 are sample modules for various menu categories that may be served at the restaurant, more may be added, different types of categories may be used, or fewer modules may be available. One of ordinary skill in the art will recognize that the disclosed system may be modified to capture any sort of food and drink items sold at a restaurant. Once a module 138 through 178 is selected, the user will have the option, as shown by the option selection diamond 186, to select the “Image of Plate, Specification of a selected Dish, POS (Point of Sale) abbreviation, and a description of the selected Dish” module 182, and/or the “Quiz questions related to specific plate” module 190. If module 182 is selected, the user will activate the “With one touch, switch to any image of another plate within that plate category” module 194, which allows the user to select any image or word description of a particular plate in the module selected 138-178 through a selection means (touch screen, mouse, keypad, keyboard, voice activation). If module 190 is selected then the “Quiz with ability to switch languages at any question” module 198, and/or “quiz with option to show correct answers as user commits an error to improve level of interactive learning” module 200, and/or the “quiz grades and records each answer for future review in choice of language module” 204 will activate while the user answers the quiz.

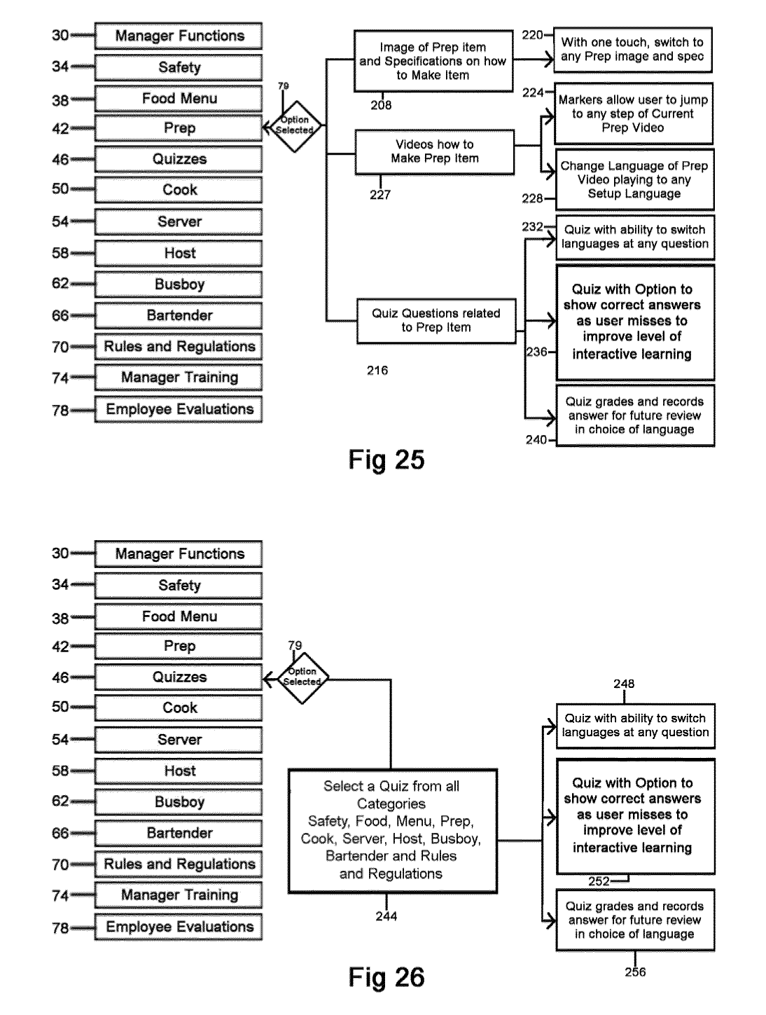

FIG. 25 is a diagrammatic illustration of one embodiment of the training system for use in a Restaurant embodiment, but where the option selection diamond 79 is now moved by the user to select the “Prep” module 42. Once the module 42 is selected, the user will have the option to select the “Image of Prep Item, Specification on how to make prep item” module 208, and or “Videos of how to make any prep item” module 212, or the “Quizzes related to prep items” module 216. If module 208 is selected, the user will activate the “With one touch, switch to any prep item image and spec” module 194, which allows the user to select any image or word description of a particular prep item through a selection means (touch screen, mouse, keypad, keyboard, voice activation). If the user selects module 212, then the “Markers allow user to jump to any chapter of current prep video” module 224, and/or the “change language of prep video playing to any setup language” module 228 will activate. Module 224 may have sub-modules, that allow a user to view any of the various videos with respect to the specific restaurant prep item that the user wants to be trained on. If the user selects the 216 module, then the “Quiz with ability to switch languages at any question” module 232, and/or “quiz with option to show correct answers as user commits errors to improve level of interactive learning” module 236, and/or the “quiz grades and records each answer for future review in choice of language” module 240 will activate for the user's quiz execution.

FIG. 26 is a diagrammatic illustration of one embodiment of the training system for use in a Restaurant embodiment, but where the option selection diamond 79 is now moved by the user to select the “Quizzes” module 46. Once the module 46 is selected, the “Select a quiz from all categories, safety, food, menu, prep, cook server, host, busboy, bartender, rules, manager training” module 244 is active, and the user can select any of the quizzes available through the module 244. Upon selection of a quiz from module 244, then the “Quiz with ability to switch languages at any question” module 248, and/or “quiz with option to show correct answers as user commits errors to improve level of interactive learning” module 252, and/or the “quiz grades and records each answer for future review in choice of language” module 256 will activate for the user.

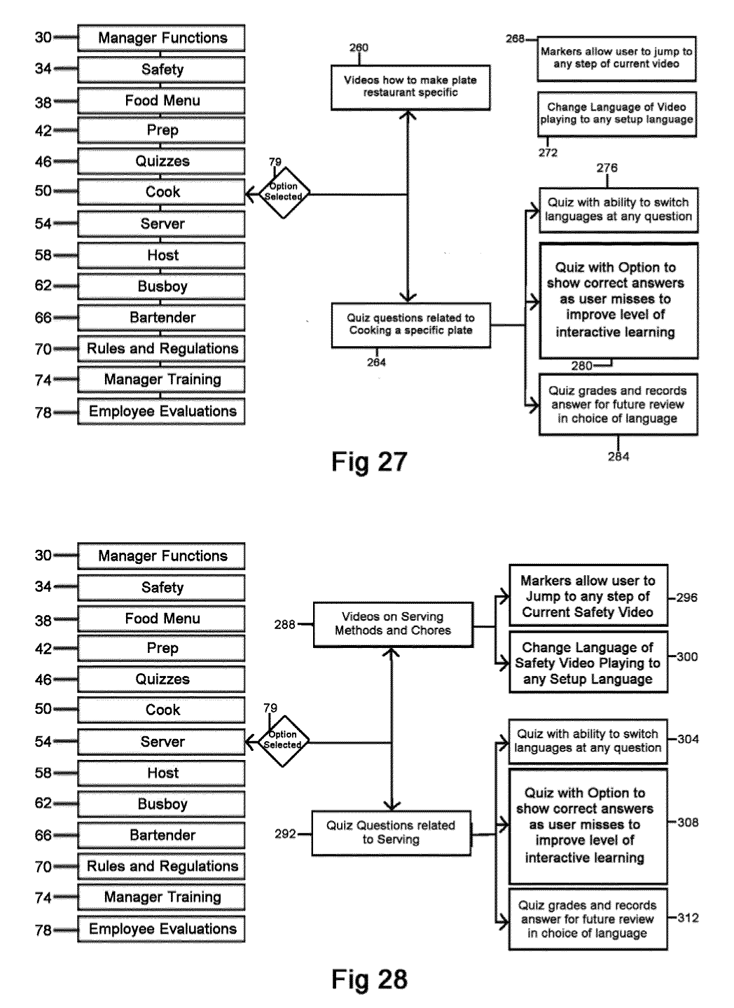

FIG. 27 is a diagrammatic illustration of one embodiment of the training system for use in a Restaurant embodiment, but where the option selection diamond 79 is now moved by the user to select the “Cook” module 50. Once the module 50 is selected, then the user has the option to select the “Videos of how to make plate (restaurant specific)” module 260, or the “Quiz questions related to cooking a specific plate” module 264. If the user selects module 260, then the “Markers allow user to jump to any step of current safety video” module 268, and/or the “change language of safety video playing to any setup language” module 272 will activate. Module 260 may have sub-modules, that allow a user to view any of the various videos with respect to the specific restaurant items that are sold for which the user wants to be trained. If the user selects the 264 module, then the “Quiz with ability to switch languages at any question” module 276, and/or “quiz with option to show correct answers as user commits errors to improve level of interactive learning” module 280, and/or the “quiz grades and records each answer for future review in choice of language” module 284 will activate for the user's quiz execution.

FIG. 28 is a diagrammatic illustration of one embodiment of the training system for use in a Restaurant embodiment, but where the option selection diamond 79 is now moved by the user to select the “Server” module 54. Once the module 54 is selected, then the user has the option to select the “Videos on serving methods and ideas” module 288, or the “Quiz questions related to serving” module 292. If the user selects module 288, then the “Markers allow user to jump to any chapter of current safety video” module 296, and/or the “change language of safety video playing to any setup language” module 300 will activate. Module 296 may have sub-modules, that are allow a user to view any of the various videos with respect to the specific server items which the user wants to be trained on. If the user selects the 292 module, then the “Quiz with ability to switch languages at any question” module 304, and/or “quiz with option to show correct answers as user commits errors to improve level of interactive learning” module 308, and/or the “quiz grades and records each answer for future review in choice of language” module 312 will activate for the quiz taking done by the user.

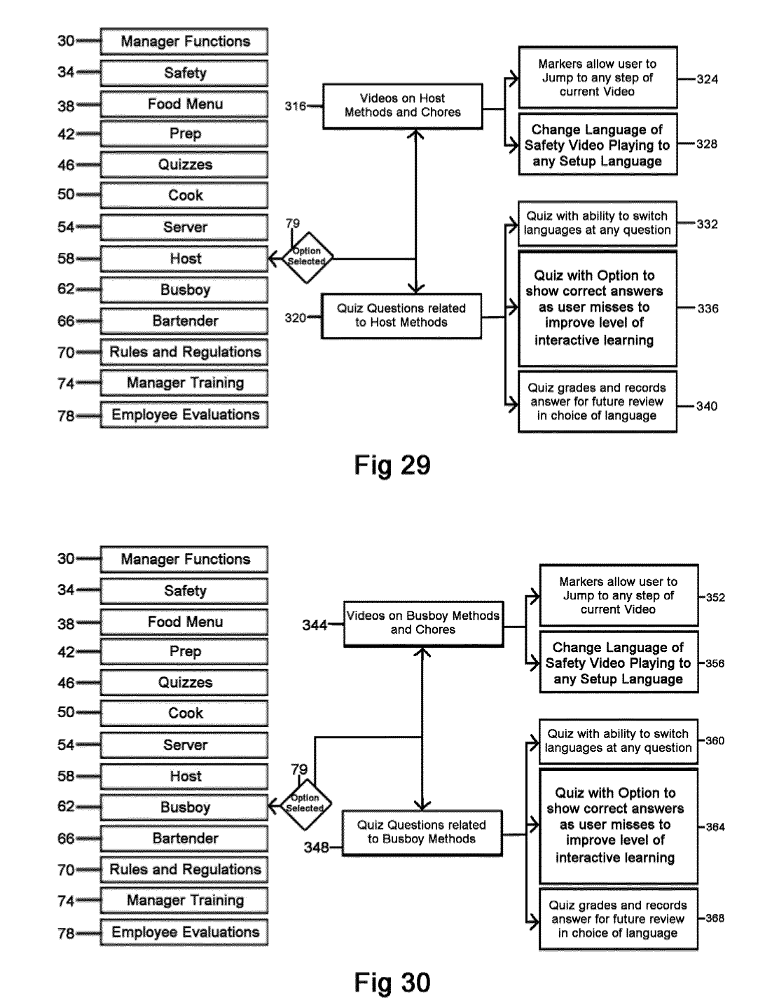

FIG. 29 is a diagrammatic illustration of one embodiment of the training system for use in a Restaurant embodiment, but where the option selection diamond 79 is now moved by the user to select the “Host” module 58. Once the module 58 is selected, then the user has the option to select the “Videos on host procedures and chores” module 316, or the “Quiz questions related to host methods” module 320. If the user selects module 316, then the “Markers allow user to jump to any chapter of current safety video” module 324, and/or the “change language of safety video playing to any setup language” module 328 will activate. Module 324 may have sub-modules, that are allow a user to view any of the various videos with respect to the specific server items which the user wants to be trained on. If the user selects the 320 module, then the “Quiz with ability to switch languages at any question” module 332, and/or “quiz with option to show correct answers as user commits errors to improve level of interactive learning” module 336, and/or the “quiz grades and records each answer for future review in choice of language” module 340 will activate for the user's quiz execution.

FIG. 30 is a diagrammatic illustration of one embodiment of the training system for use in a Restaurant embodiment, but where the option selection diamond 79 is now moved by the user to select the “Busboy” module 62. Once the module 62 is selected, then the user has the option to select the “Videos on busboy methods and chores” module 344, or the “Quiz questions related to busboy methods” module 348. If the user selects module 344, then the “Markers allow user to jump to any chapter of current safety video” module 352, and/or the “change language of safety video playing to any setup language” module 356 will activate. Module 344 may have sub-modules, that are allow a user to view any of the various videos with respect to the specific busboy items which the user wants to be trained on. If the user selects the 348 module, then the “Quiz with ability to switch languages at any question” module 360, and/or “quiz with option to show correct answers as user commits errors to improve level of interactive learning” module 364, and/or the “quiz grades and records each answer for future review in choice of language” module 368 will activate for the user's quiz execution.

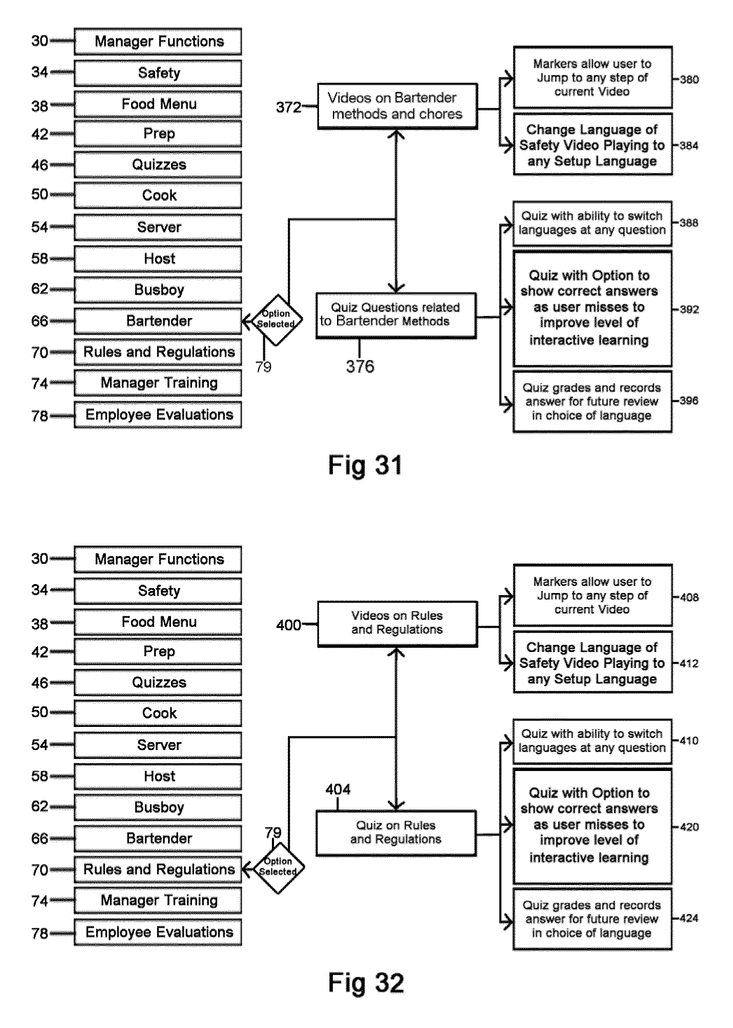

FIG. 31 is a diagrammatic illustration of one embodiment of the training system for use in a Restaurant embodiment, but where the option selection diamond 79 is now moved by the user to select the “Bartender” module 66. Once the module 66 is selected, then the user has the option to select the “Videos on bartender methods and chores” module 372, or the “Quiz questions related to bartender methods” module 376. If the user selects module 372, then the “Markers allow user to jump to any chapter of current safety video” module 380, and/or the “change language of safety video playing to any setup language” module 384 will activate. Module 372 may have sub-modules, that are allow a user to view any of the various videos with respect to the specific bartender items which the user wants to be trained on. If the user selects the 376 module, then the “Quiz with ability to switch languages at any question” module 388, and/or “quiz with option to show correct answers as user commits errors to improve level of interactive learning” module 392, and/or the “quiz grades and records each answer for future review in choice of language” module 396 will activate for the user's quiz execution.

FIG. 32 is a diagrammatic illustration of one embodiment of the training system for use in a Restaurant embodiment, but where the option selection diamond 79 is now moved by the user to select the “Rules and Regulations” module 70. Once the module 70 is selected, then the user has the option to select the “Videos of on Rules and Regulations” how to make plate (restaurant specific)” module 400, or the “Quiz on Rules and regulations” module 404. If the user selects module 400, then the “Markers allow user to jump to any chapter of current video” module 408, and/or the “change language of video playing to any setup language” module 412 will activate. Module 400 may have sub-modules, that allow a user to view any of the various videos with respect to the specific rules and regulations which the user wants to be trained on. If the user selects the 404 module, then the “Quiz with ability to switch languages at any question” module 416, and/or “quiz with option to show correct answers as user commits errors to improve level of interactive learning” module 420, and/or the “quiz grades and records each answer for future review in choice of language” module 424 will activate for the user's quiz execution.

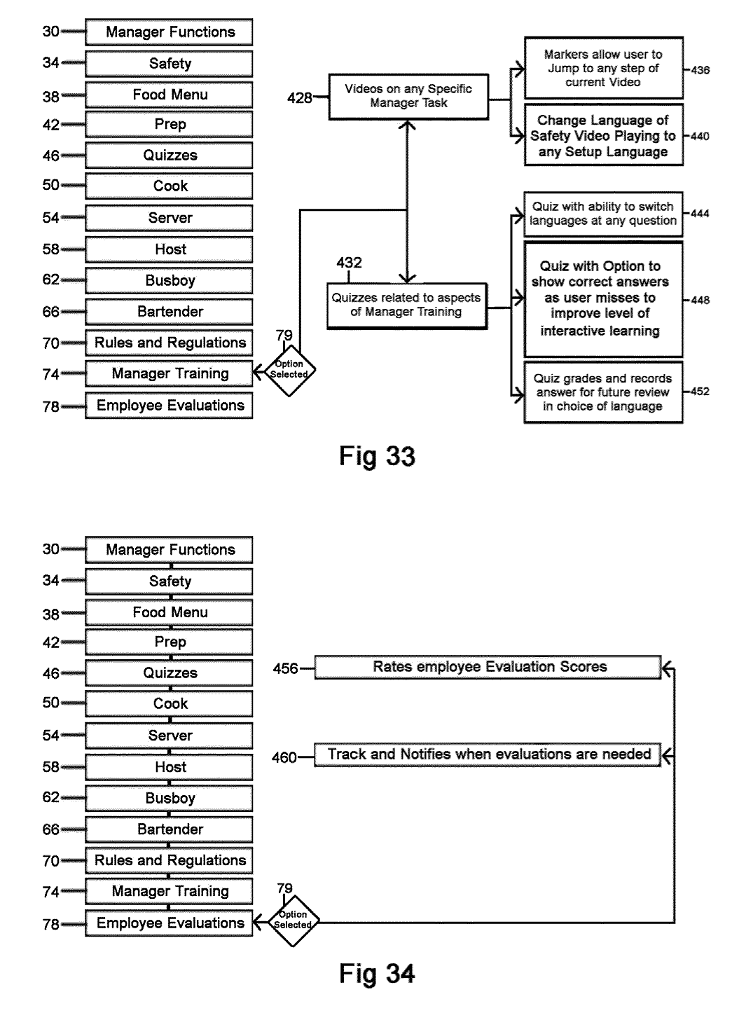

FIG. 33 is a diagrammatic illustration of one embodiment of the training system for use in a Restaurant embodiment, but where the option selection diamond 79 is now moved by the user to select the “Manager Training” module 74. Once the module 74 is selected, then the user has the option to select the “Videos on any specific manger task” module 428, or the “Quizzes related to aspects of manager training” module 432. If the user selects module 428, then the “Markers allow user to jump to any chapter of current safety video” module 436, and/or the “change language of safety video playing to any setup language” module 440 will activate. Module 428 may have sub-modules, that allow a user to view any of the various videos with respect to the specific manager tasks which the user wants to be trained on. If the user selects the 432 module, then the “Quiz with ability to switch languages at any question” module 444, and/or “quiz with option to show correct answers as user commits errors to improve level of interactive learning” module 448, and/or the “quiz grades and records each answer for future review in choice of language” module 452 will activate for the user's quiz execution.

FIG. 34 is a diagrammatic illustration of one embodiment of the training system for use in a Restaurant embodiment, but where the option selection diamond 79 is now moved by the user to select the “Employee Evaluations” module 78. Once the module 78 is selected, then the “Rates employee evaluation scores” module 456 activates, and/or the “Track any notifies when evaluations are needed” module 460 activates.

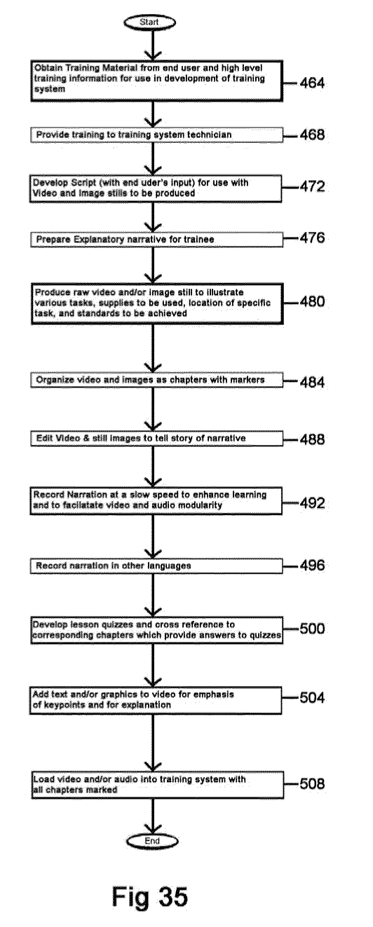

FIG. 35 is a flowchart of disclosing one embodiment of the disclosed s one page showing a method of how to create an automated training system for retail establishments, health care offices or businesses, hospitality establishments (such as hotels, spas, etc), and restaurants that can be embodied in the disclosed training method. At act 464 a training system technician (one who has been trained in developing training programs using the disclosed training system) obtains training material from an end user and high level training information from the end user for use in the development of a training program for the training system. At act 468, the end user provides training to the training system technician. Such training may take about 1 to 2 days. In some circumstances, much less training may be required, or much more training may be required, to get a training system technician up to speed such that he can properly develop a training system for the end user. At act 472 the training technician, with the end user's input, will develop a script for use with video and image stills to be produced. Act 472 may also include automated training review and comments on training script for video. This means that an organization will review and make comments on the script to be used for a new video. At act 476 the training system technician and/or the end user prepares an explanatory narrative for the trainees who will be using the training system to be trained in their jobs. At act 480 the training system technician and/or the end user produces raw video and/or image stills to illustrate various tasks, supplies to be used, location of specific task, and standards to be achieved. The raw video may be taken at the work site where the employees/trainees will work to facilitate training. At act 484 the training system technician and/or the end user organizes the raw video and still images as chapters with markers. This will allow the trainees, when they are actually using the training system, to go back to a previous chapter marker in a video, or skip ahead to other chapter markers. At act 488 the training system technician and/or the end user edits the video to tell the story of the narrative of the script. At act 492 the training system technician and/or the end user records narration at a slow speed to enhance learning and to facilitate video and audio modularity. The speed of the recording may be at about eighty percent (80%) s of normal English conversational speed. This slowed rate of English narration assists English speakers in better comprehension and allows better interchangeability of non-English languages audio files which may not be as time efficient as English in relating concepts within the time confines of the English language automated training videos. Of course other speeds may be used as warranted by the trainees and difficulty of the training. At act 496, the training system technician and/or the end user records narration in other languages, such as but not limited to Spanish, Portuguese, Chinese, French, etc. At act 500, the training system technician and/or the end user develops lesson quizzes and cross-reference the quizzes to the corresponding chapters, where the answers to the quizzes may be found. At act 504, the training system technician and/or the end user adds text and/or graphics to the video for emphasis of key points and for explanation of the material the trainee is being trained on. At act 508, the training system technician and/or the end user loads the video, image stills, and/or audio into training system with all chapters marked into a terminal, or server that is in communication with one or more terminals, or computer that is in communication with one or more terminals. Now the training system is ready to be used by the trainees/employees.

The system has a specific method for reducing production time of the automated training videos centered on the audio file production which then becomes the foundation of the video. This method reduces time to create an automated training video on any subject and it reduces time to update the automated training in the future by making it modular and it improves quality of the video by reducing errors in the production of the audio and video components of the video. Each sentence of the automated training script is recorded separately and then issued a unique serial number that identifies the initial date and time of production with a string of numeric characters that also uniquely associates the audio file with the sentence content and then identifies the language with a two alpha character suffix which identifies the language, for example, “EN” for English. For assembly of the sentences into a complete automated training video, the sentence audio files are then renamed with a simple code prefix that identifies in exactly what sequence the particular sentence or audio file is presented in the video. The sentence video files is normally recorded first in English at about 80% of normal English conversational pace so that narrated message takes about 25% longer than normal conversational English. The elapsed time for the sentence without pauses at either the beginning or the end of the sentence then establishes the time objective for the same sentence to be created in other languages. Where needed the translator is encouraged to reduce or add words without changing the meaning in order to match the elapsed time for the sentence recording with the English standard. The English sentences of a paragraph are strung together with standard length pauses of one second between each sentence and the total paragraph time in English with standard pauses then becomes the time objective for the other languages. The key production requirement is that the string of sentences comprising each paragraph with varying pause lengths between the sentences reasonably closely match in elapsed time in all languages so that small variations in pauses between sentences allows each paragraph to start at exactly the same moment among all languages. This allows the production of only one video file that matches all audio files no matter what language which simplifies and reduces production time on the first video and production time for updates thereafter.

After a person has watched a video lesson, the system can then automatically introduce a quiz or test comprised of a number of multiple choice and true and false questions. The system records the beginning and ending time for the quiz to be completed and automatically checks the answers of the viewer to determine a score correct and grades the quiz/test. This score or grade is then recorded for the person and a report is automatically sent to the person(s) earlier specified to the system who should receive the report of the viewer's competency achieved as measured by the quiz/test score. The system will furnish in this automatically generated and emailed report an analysis and comparison as to how this person's competency compares with other viewers historically and puts the level of competency achieved in perspective generally for the manager of the person who can then use this information to better assign activities and retraining if appropriate.

The system has the ability to monitor frequency of training and re-training. For instance, certain training is required by the federal government to be given and documented on a regular basis. Lock Out/Tag Out is an example of federally mandated frequency training that is required annually for persons working around heavier equipment. The system ensures that a new person receives the training during a prescribed period following date of hire or notifies the appropriate manager of the unmet training need. If the training is still not conducted, the system re-notifies the appropriate manager and begins a process of working up the “chain of command” among managers to help ensure that the missed training is increasingly likely to be noticed and acted upon. Similarly, the system notifies in advance as per parameters established by the end user appropriate persons when re-training is coming due and then again notifies staff as prescribed if the training is not actually conducted successfully.

Ad hoc training reports can be requested by any authorized person as needed to summarize past training for any individual, including comprising data on times taken to review, quiz/test scores, times taken to complete quiz/tests, grade history, etcetera and then to compare with other persons who have been through the training.

Similarly ad hoc training reports can be requested by any authorized person as needed to summarize for any video, including comprising data on times taken to review listing individuals or average times, quiz/test scores, times taken to complete quiz/tests, grade history, etcetera and then to compare with other automated training videos.

Reports can be automatically scheduled to summarize automated training activities reporting to any person in the organization as designated to provide overall period. This report can comprise non-compliance issues with training schedule requirements, assessment of competency levels received by individuals or by video for the period, etcetera. This report can report at an organizational level or department level within the organization so that a manager may “drill” down in his review to the level helpful in responding to opportunities presented for improvement by the activities reporting.

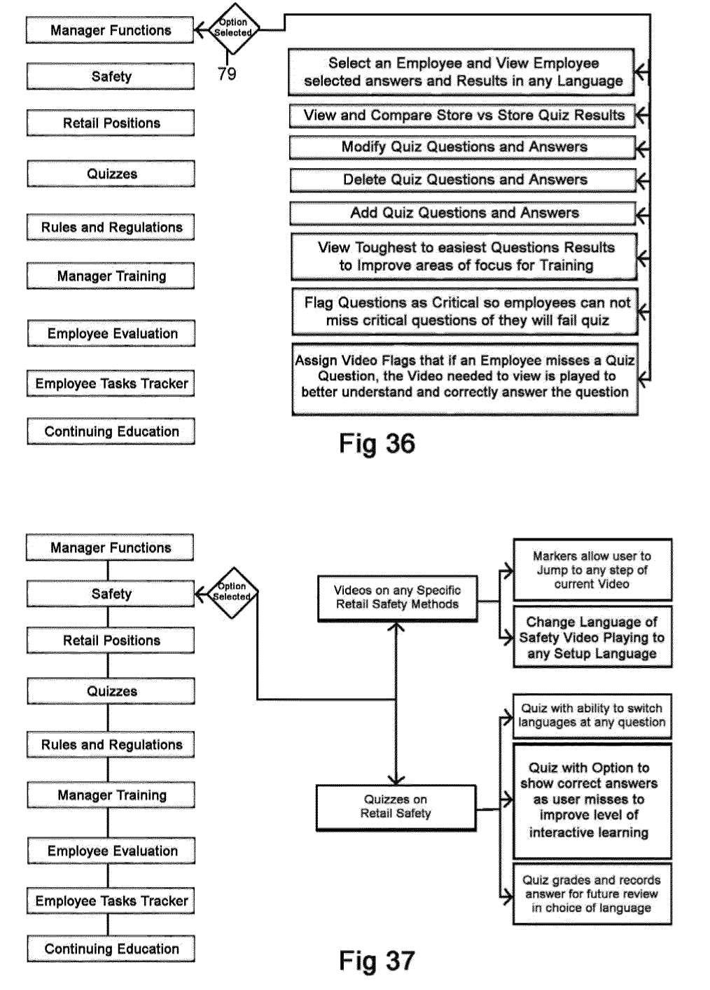

Attached as FIGS. 36-44 are 9 pages of diagrammatic illustrations illustrating how the disclosed training system apparatus may be structured in a Retail embodiment.

Attached as FIGS. 45-51 are 8 pages of diagrammatic illustrations illustrating how the disclosed training system may be structured in a Health Care embodiment.

Attached as FIGS. 52-60 are 9 pages of diagrammatic illustrations illustrating how the disclosed training system may be structured in a Hotel embodiment.

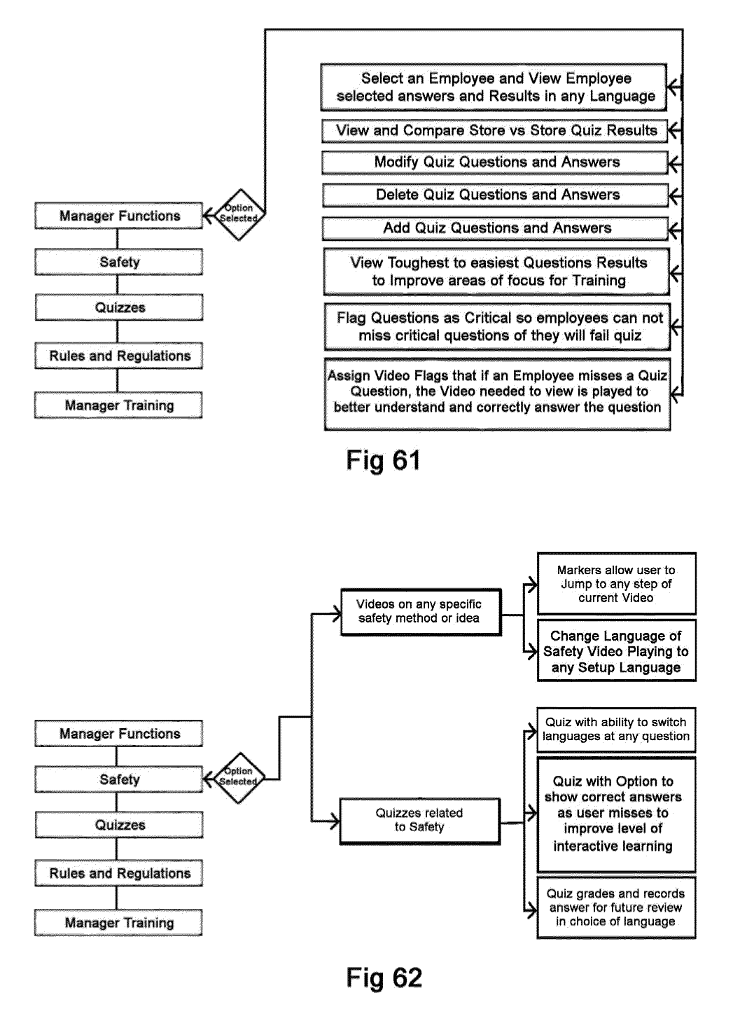

Attached as FIGS. 61-66 are 6 pages of diagrammatic illustrations illustrating how the disclosed training system may be structured in a general industry embodiment.

Attached as FIGS. 66-74 are 9 pages of diagrammatic illustrations illustrating how the disclosed training system may be structured in a production embodiment.

The disclosed embodiment also includes an embodiment where the terminal is a hand held device used by an employee, such as a hostess/servers to be used as a tool to help up sell more expensive menu items and help educate customers on their menu. The device is likely to be the size of an ultra-mobile pc, and may be used by touch screen, and will possibly include calorie information, allergic information, some to all ingredients, and hopefully an abbreviated video showing how the plate is made. Also included would be a full screen image helping the customer clearly see what it is they're ordering. With respect to the restaurant industry, many customers may not be completely familiar with all items on a menu, and those customers would greatly benefit from a little helpful video and/or pictures shown to them by employees, thereby increasing employee tips and service ability, and increasing higher priced item selling.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A training system comprising:
a terminal,
a cpu located in the terminal;
a storage means in signal communication with the cpu;
an input means located on the terminal and in signal communication with the cpu;
a terminal screen located on the terminal and in signal communication with the cpu;
a training module located on the storage means, the training module comprising:
at least one training video with user selectable chapter markers located at preprogrammed intervals on the training video;
an employee evaluations module located on the storage means that alerts a supervisor when an employee should receive training on a specific subject, when an employee has watched certain videos and has completed training, and that provides results of all employee quizzes to the a person directed by an operator of the training system.

2. The training system of claim 1, wherein the terminal screen is a touch screen.

3. The training system of claim 1, wherein the storage means is located in a server.

4. The training system of claim 2, wherein a plurality of terminals are in signal communication with the server.

5. The training system of claim 1, wherein the storage means is located in the terminal.

6. The training system of claim 1, wherein the training module further comprises:
a manager functions module;
a safety module;
a quizzes module;
an employee positions module;
a rules and regulations module;
a miscellaneous training module;
a manager training module;
an employee evaluations module;
an option selection module in removable communication with each of the seven modules listed above;
a select an employee and view employee selected answers and results in any language module in signal communication with the manager functions module;
a view and compare store vs. store quiz results module in signal communication with the manager functions module;
a modify quiz questions and answers module in signal communication with the manager functions module;
a delete quiz questions and answers module in signal communication with the manager functions module;
an add quiz questions and answers module in signal communication with the manager functions module;
a view toughest to easiest questions results to improve areas of focus for training module in signal communication with the manager functions module;
a flag to mark questions as critical so employees cannot miss critical questions or they will fail quiz module in signal communication with the manager functions module;
an assign video flags that if an employee commits and error answering a quiz question, the flag shows what video the employee needs to watch to better understand and correctly answer the question, if there is a video module in signal communication with the manager functions module;
a video of any specific safety method module in communication with the safety module;
a quizzes related to safety module in communication with the safety module;
a markers allow user to jump to any chapter of current safety video module in communication with the videos of any specific safety method module;
a change language of safety video playing to any setup language module in communication with the videos of any specific safety method module;
a quiz with ability to switch languages at any question module in communication with the quizzes related to safety module;
a quiz grades and records each answer for future review in choice of language module in communication with the quizzes related to safety module;
a select a quiz from all categories module is in communication with the quizzes module;
a quiz with ability to switch languages at any question module is in communication with the select a quiz from all categories module;
a quiz with option to show correct answers as user commits errors to improve level of interactive learning module is in communication with the select a quiz from all categories module;
a quiz grades and records each answer for future review in choice of language module is in communication with the select a quiz from all categories module;
a videos on employee positions methods module is in communication with the employee positions module;
a quiz questions related to employee positions module is in communication with the employee positions module;
a markers allow user to jump to any chapter of current video module is in communication with the videos on employee positions methods;
a change language of safety video playing to any setup language module is in communication with the videos on employee positions methods;
a quiz with ability to switch languages at any question module is in communication with the quiz questions related to employee positions module;
a quiz with option to show correct answers as user misses to improve level of interactive learning module is in communication with the quiz questions related to employee positions module;
a quiz grades and records each answer for future review in choice of language module is in communication with the quiz questions related to employee positions module;
a videos on specific rules and regulations module is in communication with the rules and regulations module;
a quiz questions related to rules and regulations module is in communication with the rules and regulations module;
a markers allow user to jump to any chapter of current video module is in communication with the videos on specific rules and regulations module;
a change language of safety video playing to any setup language module is in communication with the videos on specific rules and regulations module;
a quiz with ability to switch languages at any question module is in communication with the quiz questions related to rules and regulations module;
a quiz with option to show correct answers as user commits errors to improve level of interactive learning module is in communication with the quiz questions related to rules and regulations module;
a quiz grades and records each answer for future review in choice of language module is in communication with the quiz questions related to rules and regulations module;
a videos on any specific manger task module is in communication with the manager training module;
a quizzes related to aspects of manager training module is in communication with the manager training module;
a markers allow user to jump to any chapter of current safety video module is in communication with the videos on any specific manger task module;
a change language of safety video playing to any setup language module is in communication with the videos on any specific manger task module;
a quiz with ability to switch languages at any question module is in communication with the quizzes related to aspects of manager training module;
quiz with option to show correct answers as user commits errors to improve level of interactive learning module is in communication with the quizzes related to aspects of manager training module;
a quiz grades and records each answer for future review in choice of language module is in communication with the quizzes related to aspects of manager training module;
a rates employee evaluation scores module is in communication with the employee evaluations module; and
a track any notifies when evaluations are needed module is in communication with the employee evaluations module.

7. A method of developing a training program for use in a training system, the method comprising:
obtaining, by a training system technician, training material and high level training information from an end user for use in the development of a training program for a training system;
providing training to the training system technician by the end user;
developing script with end user's input for use with video and image stills to be produced;
preparing an explanatory narrative for trainees who will be using the training system;
producing raw video and/or image stills, which raw video and/or image stills will be used to train trainees;
organizing the raw video and still images as chapters with markers;
editing the video and still images to tell a story of the narrative of the script;
recording narration at a slow speed to enhance learning and to facilitate video and audio modularity;
recording narration in other languages;
developing lesson quizzes and cross-referencing the quizzes to corresponding chapters;
adding text and/or graphics to the video for emphasis of key points and for explanation of the material the trainee is being trained on; and
loading the video, image stills, and/or audio into training system with all chapters marked onto a storage means accessible by a terminal.
